(19) United States
(12) Patent Application Publication
(10) Pub. No.: US 2013/0165238 A1
(43) Pub. Date: Jun. 27, 2013

(54) SYSTEMS AND METHODS FOR AN INTERNET COMPETITION NETWORK

(71) Applicant: Dionicio MELCHOR BATISTA JEREZ, Santo Domingo (DO)

(72) Inventor: Dionicio MELCHOR BATISTA JEREZ, Santo Domingo (DO)

(21) Appl. No.: 13/729,157

(22) Filed: Dec. 28, 2012

Related U.S. Application Data
(66) Substitute for application No. 13/374,421, filed on Dec. 27, 2011.
(60) Provisional application No. 61/631,150, filed on Dec. 28, 2011.
(60) Provisional application No. 61/631,145, filed on Dec. 28, 2011.
(60) Provisional application No. 61/631,147, filed on Dec. 28, 2011.
(60) Provisional application No. 61/631,146, filed on Dec. 28, 2011.
(60) Provisional application No. 61/631,148, filed on Dec. 28, 2011.
(60) Provisional application No. 61/631,149, filed on Dec. 28, 2011.
(60) Provisional application No. 61/631,152, filed on Dec. 28, 2011.
(60) Provisional application No. 61/631,151, filed on Dec. 28, 2011.

(51) Int. Cl. A63F 13/12

(52) U.S. Cl. CPC A63F 13/12
USPC 463/42

(57) ABSTRACT

A service that allows users to collect, process and share data about competition and recreational activities. Human, Organization or Robot users using any internet connected device are provided with a single profile where they can view their data, challenge other users and be judged by other users. The service also allows users to add all means they use to compete as Dependent members such as Animals, Plants, Vehicles, Humans, Teams and Tools. The service also provides means for users to create activities with custom data types, formulas and ranking systems as a representation of an existing live or virtual activity or a variation of an existing one. Relationships between users and user roles are automatically assigned based on operations they do. Users can compare two or more elements of the network or just follow any element of the network receiving constant updates about topics of their interest.

### CROSS REFERENCE TO RELATED APPLICATIONS

U.S. Ser. No. 13/374,421: INTERNET COMPETITION NETWORK
U.S. 61/631,150: SYSTEMS AND METHODS FOR DEFINING USER CUSTOM RANK SYSTEM ON AN INTERNET COMPETITION NETWORK OR SOCIAL NETWORK
U.S. 61/631,144: SYSTEMS AND METHODS FOR SEARCHING ON AN INTERNET COMPETITION NETWORK
U.S. 61,631,145: SYSTEMS AND METHODS FOR DYNAMICALLY COMPARING GEOGRAPHIC REGIONS BASED ON DATA OF AN INTERNET COMPETITION NETWORK
U.S. 61/631,147: SYSTEMS AND METHODS FOR DEFINITION OF A CUSTOM COMPETITION ACTIVITY ON AN INTERNET COMPETITION NETWORK OR SOCIAL NETWORK
U.S. 61/631,146: SYSTEMS AND METHODS FOR DEFINITION OF CUSTOM FORMULAS FOR AN INTERNET COMPETITION NETWORK ACTIVITY ON AN INTERNET COMPETITION NETWORK OR SOCIAL NETWORK.
U.S. 61/631,148: SYSTEMS AND METHODS FOR CHALLENGE MANAGING BETWEEN USERS OF AN INTERNET COMPETITION NETWORK OR SOCIAL NETWORK
U.S. 61/631,149: SYSTEMS AND METHODS FOR DYNAMICALLY CALCULATING USER REPUTATION ON AN INTERNET COMPETITION NETWORK OR SOCIAL NETWORK.
U.S. 61/631,152: SYSTEMS AND METHODS FOR DYNAMICALLY GENERATING INTERNET COMPETITION NETWORK USER PROFILES
U.S. 61/631,151: SYSTEMS AND METHODS FOR COMPETITION EVENT MANAGEMENT ON AN INTERNET COMPETITION NETWORK OR SOCIAL NETWORK

### BACKGROUND OF THE INVENTION

Species have competed since the beginning of time for food, mating or survival. Unlike other living species most of the modern human competition activities are for fun, recreation or personal growth. With the exception of war which is the highest level of competition, most of the modern competition activities are designed to cultivate the human body, using the body as a competition element or competing alongside others means like vehicles, animals or tools.

One particular problem is that most of the data generated by actual competition activities like amateur sports, beauty contests, farm fairs or paint contests are not recorded or taken into account by actual social networks. This leads to the situation where each organization that wants to promote their members records and achievements have to develop and maintain a separate website, making the data of a particular activity dispersed and disorganized.

Data on small organized networks like video games are segregated due to competition between companies. Users who have more than one console or mobile device game don't have a central place to see the data and achievements they generate on networks like Xbox live, PlayStation network or Battlenet.

Sports social networks are still tied to the Social network model requiring the users to join and post their data without a means of validation from the organization they belong. Those networks are in their majority followers of big sports activities giving their members only the information from well-established sports and teams. Another drawback of the Sports social networks is that they lack a tool where the users can create their own sports or recreational activities, forcing the users to choose from a set of pre-defined activities from well known sports with no form of modification or customization.

Second, there is a need for recreational institutions or little sports leagues like little league baseball, football or amateur soccer for a centralized tool to keep and maintain current and historical data about their members due to lack of resources; that leads to professional and well established sports getting almost all attention from the fans.

The adaptation and following of rules when a small organization joins a regional, national or international organization also presents difficulties when maintaining their websites. Sports and recreational organizations always have little variations of the rules depending on geographical region, age or staff preferences.

Another limitation is that most of the current networks are constructed based on what users like, not on what they do or have; making it difficult for users who share a common activity to find each other, to share experiences or to team up. It is said that many people like baseball or football but not all of them practice those sports.

Examples of operations that users can't make on actuals networks are:
A) Find Photographers who live in Boston and have a D-SLR camera Canon 7D and invite them to a photo safari.
B) Find Hip Hop dancers that graduated at Olmsted Performing Arts Dance Academy and invite them to a dance contest.
C) Find a female singer, a drummer and two guitar players and contact them to form a rock band
D) Find all 2011 Chevrolet Camaro owners from Florida and contact them to form a Camaro owner's club.
E) Find and Contact a female British Bulldog owner from The Bronx, N.Y. to ask for assistance and recommendations.
F) Find golf players who live in Toronto, Canada and have a handicap of 10 and invite them to participate in a golf tournament.
G) Compare two geographic regions based on competition or activities data.
F) Vote as “Dislike” or rate as 1 to 5 stars on people, topics or organizations.

Rare competition activities have little or no support on the web, making them difficult to discover by other people out of their local communities. Competitors of math tournaments, mustache contest, extreme sports or garden contests rarely see their data or achievements on the web. In most cases even if a small organization has their website, data about competition events is disorganized and is not maintained over time. This is causing that a web site visitor can't see in most cases who were the best competitors or winners from previous years.

On the other hand, most of the current social networks require that users must declare a close relationship with other user to allow them to interact. Users are forced to declare their teachers, trainers, mentors, roommates and teammates as friends even if they're not considered as friends by the users.

Other main limitation of current networks is that their design is specifically for connecting people; animals, pets, plants, vehicles, gadgets and tools are out of their operational model. Animals in some cultures are considered as part of the family and people love to talk and share information about their pets. On the other hand people who have some tool, vehicle or gadget find it difficult to find and associate with others because they find it difficult to find people based on what they have. Lots of people like the Chevrolet Camaro, but even fewer people have a Chevrolet Camaro.

One big obstacle for actual networks is that COPPA (Children Online Privacy Protection Act) law establishes that websites who directly collect information from children must have a written consent from their parent if the child is younger than 13 years of age, making it difficult to collect competition data from underage people. The lack of an automated process for the request and approval from the parents about activities and achievements of their children is causing difficulties for web based networks to include underage people. Also the before mentioned law requires that websites must physically delete at a parent request all data that could lead to directly contacting the child, making it difficult to design websites with databases that can support orphan data.

Also talent seekers lack a tool to compare talented competitors (men, animals, machines or tools) from different geographic regions, disciplines and ages, by using their own search methods, formulas or calculation criteria to compute raw data the way they want.

The lack of an administration tool where a person can direct and administer all aspects of a competition or recreational activity is preventing that nonprofessional sports organizations from posting their information to the internet. In addition most of the professional organizations lack a tool for posting historic data from each member, leaving that data on paper sheets on files in their offices, causing historic information on competition and recreational activities to disappear with time because of the deterioration of those sheets.

Other organizations have spreadsheets to manage their data, which in the long run can cause data loss due to the lack of backup procedures, or it could be tedious to maintain data and rules when new data is added each year.

Therefore a new type of network must be established with a total differentiation from social networks with its own set of rules, user types, member interactions, activities and user policies and the addition of other non-human competitors such as animals, plants, vehicles or tools.

### SUMMARY OF THE INVENTION

The invention is comprised by systems and methods to allow internet connected users to record, evaluate and maintain data related to virtual or live activities. The data generated on those activities are concentrated into a single user profile. Users with elevated privileges can create activities on the network with their custom set of data types, rules and ranking systems to mimic a virtual or live activity. Users can also add dependent profiles which can accommodate all means they use to compete such as animals, plants, tools, gadgets, vehicles, humans, organizations or teams. Also follower users can subscribe to receive continuous up to date information about other users, organizations, dependents, events or activities.

Internet enabled services are provided to allow a group of users such as people, organizations or artificial intelligences to connect, follow and compete between them. The system receives its configuration parameters, formulas for data calculation, preferences for ranking top competitors, user roles and privileges from one or more databases located on one or more servers. Parameters can be predefined to mimic well known competition activities like baseball or football or can be created from scratch by users with elevated privileges (Commissioner role) to mimic any virtual or live activity. Also users are provided with templates with data, rules and raking systems of most popular sports and competition activities which they can modify and adapt to their preferences.

Using any internet connected device such as cellphones, smartphones, tablets, laptops, desktop computers, video game consoles, portable video game consoles, smart TVs or PDAs one or more users can connect to a central or distributed server farm. Operations on this server farm are performed on multiple servers such as web servers, database servers, application servers, mobile app servers, backup servers, security servers or load balancing servers.

Information in the network can be stored on SQL and No-SQL databases; information in the database is comprised of but not limited to general information on each user such as name or email, general or detailed data about competition activities and roles that users have in the network. Users can have one or more roles in the network. User roles govern what users can do or see on the network.

A user relates or interacts with others based on their competition data, members can then have conversations and communicate between themselves if they belong to a team or organization or if they compete against each other in an event. In an Internet Competition Network there is no such thing as friend request, family request or discussion groups. Users interact with each other with competition driven relationships such as teammate, roommate, mentor, colleague, rival or opponent.

Users are also evaluated by a reputation system based on his participation in one or more events, the results of those events affects the reputation of the user, main data types can be used to calculate user reputation such as won, lost or disqualification; but other actions can lower the reputation of any given user like not attending to an previously confirmed event.

Competitor Users can set preferences based on user reputation; an example could be a Competitor User not accepting challenge requests from others competitors users with reputation lower than 90%; however not accepting certain number of challenge requests can also lower the reputation of the Competitor User.

Arbiters also governed by the reputation system, in that manner the decision of an arbiter can be impugned by participating users on the event that he judged. In that sense not attending to events and the total of dislikes he receives can lower his reputation. When attending to an event, competitors can see the Arbiters and their reputation, and are also able to propose another arbiter in case the reputation of the selected arbiters does not meet with the expectations.

User roles in the network are as follows:
a) Follower: follows other users, organizations, competitors and their dependents.
b) Competitor: Competes on events, can challenge other competitor users.
c) Arbiter: Validates events and certify data.
d) Commissioner: Creates activities and invites to events
e) Scout: Can search for talented competitors to propose a contract or offer.
f) Sponsor: Can create activities and events related to their brand or name.
g) Annotator: Enters or capture competition data on an event
h) Administrator: Administers the network, reserved for employees of the company who runs the network.

Operations on the network are governed by one or more requests that one user sends to another, those requests can consist of:
a) Team request: invitation to associate two or more users to form a team.
b) Mentor request: request asking for assistance or tutorship.
c) Scout request: Request directed to a Commissioner user to see and evaluate data related to his activity.
d) Challenge request: Invitation directed to a Competitor user asking him to participate in an event.
e) Arbiter Request: Invitation to assist, evaluate and certify data of an event.
f) Revoke: Request directed to an Arbiter or Commissioner to review and reevaluate the results of an event, award or record.
g) Link request: Request from a Competitor user to a Commissioner user to link all data related to the first, after this request is accepted all data related to the competitor user is shown in his profile.
h) Organizational request: Invitation from a small organization to a superior organization to be accepted as a member.
i) Appeal request: request directed to a Commissioner or Arbiter user to reconsider a decision.
j) Delete request: a request from a parent to a Commissioner user or Administrator user asking him to delete all data that can lead to contact an underage child directly.

The network also allows organizations to add their members by creating standalone profiles that can be linked to users later on. Directing or staff members can add standalone profiles by registering general information about their members or specific events data. Under aged children and their parents can view their managed profiles with a parent's consent. In that sense a competitor can be part of the network without being an active user. Users 13 or older can subscribe to the network freely; under aged users will have their profile only if they're managed by other user as part of an organization. Because this model does not collect information directly from children under 13, is COPPA compliant.

Parents can send a “Delete request” to a Commissioner user on any activity, in this case the Commissioner user is obligated to delete all personal information about the child. If the Commissioner user does not respond to the request in a reasonable time frame then Administrator users can take action to attend to the parent request and comply with COPPA regulations, sending an admonition message to the Commissioner user for not responding to the request. Failing to answer several delete request from the parents can cause the Commissioner user to lose his role, and his activity can be cancelled or deactivated.

When a “Delete request” is answered by an Commissioner User or Administrator User all personal information of the user or profile is deleted from the database and the user profile is named “Deleted User”, but all data related to competition, events, awards and interaction are not deleted to maintain data consistency. An unique identifier or “ID” that identify the user or profile is maintained to keep data consistency in the databases and to reestablish the association from a user to his data in case he or his parents decide to join the network again when he grows up or if his parents change their mind. This ID is sent via email to the user or parents with information on how reestablish and reconnect his data.

The network also allows users to add as “Dependent” all means they use to compete such as animals, plants, tools, vehicles, gadgets or teams. Those dependents can compete along with the user or in his name. Each dependent has his separate profile and can be followed by other users; in this manner following users can receive updated information about a talented dog, a special vehicle or exploits of a group of people or team who are dependents of a coach or manager.

Some activities in the network could require that members need to have a certain dependent with specific characteristics in order to participate. In that manner a mountain bike activity could require a mountain bike with specific specifications, certain golf players must have a predetermined handicap to be accepted in a golf club or owners must have a Hummer H3 or Harley Davison to be accepted in a motor club.

When invited to an event where dependent competitors will be used, all attending competitors can view profiles of other attending competitors and their dependents. In that manner by example all attending competitors to a paint ball competition can see the weapons each one will use.

The network also provides means to compare any member of the network based on their competition data and other public available data. Other comparison options are the like or dislike votes and 1 to 5 stars rating system. A follower user can compare one or more Users, Organization or Geographic regions in any activity and how it was ranked on previous years.

### BRIEF DESCRIPTION OF THE DRAWINGS

The previous summary, as well as the following detailed description of the invention, is better understood when read in conjunction with the appended drawings. For the purpose of illustrating the invention, there is shown in the drawings exemplary diagrams that illustrate information flow, user roles, database entities and access rights; however, the invention is not limited to the specific methods and instrumentalities disclosed in the drawings:

FIG. 1 is a block diagram showing the internet network environment where the invention may be implemented.

FIG. 2 is a block diagram showing user types, roles and dependents members. The diagram also shows the roles and dependents members that each type of user can have. The diagram also shows the elements that a team can have.

FIG. 3 is a block diagram showing the database entities, user roles and access types.

FIG. 4 is a block diagram showing the data definition, formulas, statistics, raw data, data rules and user generated profiles related to an activity in a database engine.

FIG. 5 illustrates the creation of a competition activity on a user profile.

FIG. 6 is another illustration showing the creation of activity data types, rules and references on a user profile.

FIG. 7 is another illustration showing the process of creating competition activities formulas on a user profile.

FIG. 8 illustrates the user rank definition process of an activity.

FIG. 9 illustrates the how to send challenge requests on a Competitor user profile.

FIG. 10 illustrates pending challenge requests on a Competitor user profile.

FIG. 11 illustrates a list of pending arbiter requests on an Arbiter user profile.

FIG. 12 illustrates a list of activities on a Competitor User profile with the reputation for each one represented by a percentage number.

FIG. 13 illustrates small colored screen portions with a summary of the user's generals plus his reputation known as a mini profile.

FIG. 14 illustrates a list of activities in which a Competitor User can see his rank and reputation.

FIG. 15 illustrates a list of activities on an Arbiter user profile with the reputation for each activity represented by a percentage number.

FIG. 16 illustrates a summary of statistics and awards by activity on a Competitor user profile.

FIG. 17 illustrates a list of awards on a Competitor user profile.

FIG. 18 illustrates a list of dependent profiles on a Competitor user profile.

FIG. 19 illustrates a dependent member profile on a Competitor user profile.

FIG. 20 illustrates a live event annotation or data entry operation by an Annotator or Arbiter user.

FIG. 21 illustrates a virtual event, a discrete math tournament with real time evaluation.

FIG. 22 illustrates a following section of an event on a Follower user profile

FIG. 23 illustrates the results of a live single event and the chat session between competitor users who attended.

FIG. 24 illustrates a single elimination tournament in a Follower user profile.

FIG. 25 illustrates the results of a beauty contest event on a Follower user profile.

FIG. 26 illustrates two round robin tournaments on a Follower user profile.

FIG. 27 illustrates a search operation with some options and filters.

FIG. 28 illustrates a comparison between two geographical regions based on competition data generated on the network and other public available data.

FIG. 29 illustrates a comparison chart of scholar qualifications on a user profile

FIG. 30 shows comparison charts between several elements, showing public data from other sources combined with reputation and user rating from the competition network.

### DETAILED DESCRIPTION OF THE INVENTION

### A) Field of the Invention

This invention generally relates those activities in which a human competes with another human, machine or against a set of pre-established rules to make a record or achievement. In particular this invention is directed to live and virtual human competition activities such as sports, contests or video games.

This invention also relates to internet connected networks, web services and particularly to systems and methods to allow internet connected users to record data about live or virtual competition activities, define their own by adding data definitions and formulas to mimic any live or virtual competition activity and add all means they use to compete such as animals, plants, vehicles and tools.

The invention also relates to web services and technologies to allow non-competing users to follow or stay in touch receiving continuous up to date information about competing users, organizations, and dependents (animals, plants, vehicles or tools) they're interested in.

The invention also relates to systems and methods to compare two elements of the network based on internal data from one or more databases. This comparison can also be complemented with public available data. The comparison system can determine the winner automatically by analyzing the data and the rules containing them.

The invention is also related with systems and methods to allow users with elevated privileges to create one or more custom set of formulas and data definitions to manage the data they are in charge of; or creating custom reports with their own formulas and process steps to view the data the way that they want. Only users with the Commissioner, Sponsor or Scout roles can create said custom reports.

### B) Detailed Description

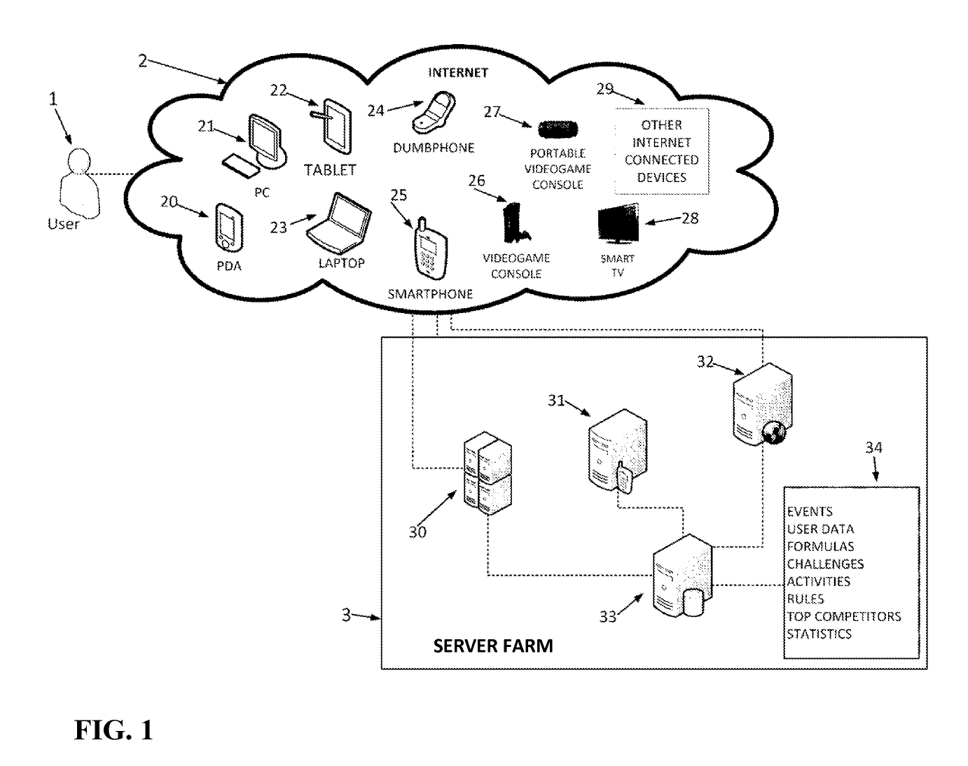

FIG. 1 is a diagram showing the internet structure where the invention is implemented. Here a user 1 connects to one or more services of the network through the internet cloud 2 using one or more internet connected devices 20-29. One or more server farms 3 is responsible of those services, the server farm comprised of one or more Application servers 30, Mobile Application servers 31, Web servers 32 or Database servers 33. Others servers can be added to the server farm to cover support operations such as load balancing, backup or firewalling.

The user 1 can be a Human, an Organization or an Artificial intelligence, the user can access the services of the network by using a portable computer or PDA 20, a desktop PC 21, a Tablet computer 22, a Laptop computer 23, a Dumb phone 24, a Smartphone 25, a Videogame console 26, a Portable videogame console 27, a Smart TV 28 or any other device that can connect to the internet cloud 29.

Server farms 3 can be located on a single geographical region or distributed across multiple regions for load balancing purposes. The Server farms 3 can be comprised of one or more of each Application server 30, Mobile app server 31, Web server 32 or Database server 33 to cover the demand of information from the users.

Application servers 30 provide connection services and perform some of the calculations to send result to connected devices 20-29 through the internet cloud 2.

Mobile app servers 31, provides connection and services for applications running on devices 20-29 connected to the internet cloud 2.

Web servers 32 are responsible for providing connection and services to web browsers running on internet connected devices 20-29.

One or more Database servers 33 store and retrieve data on demand from other servers 30, 31 and 33 elements of information 34 such as Events, User data, Formulas, Challenges, Activities, Rules, Top competitors or Statistics.

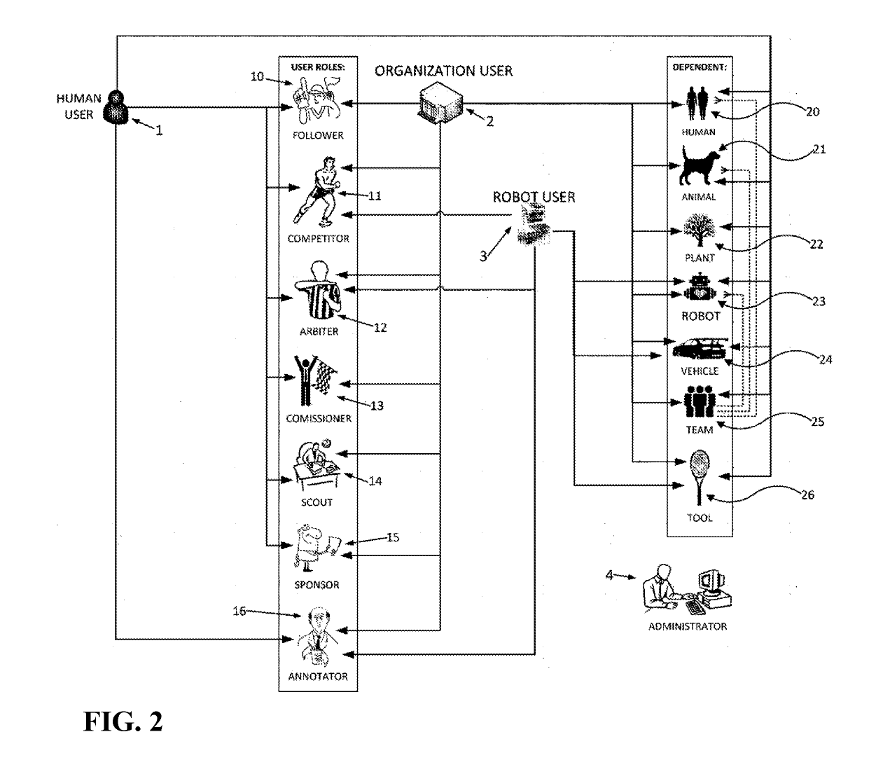

FIG. 2 is a diagram showing the user roles related to each user type and the dependents each user can have. Three types of users 1-3 can subscribe to the network to perform operations and a fourth user 4 that performs administrative tasks and enforces user policies of the company that runs the network.

A Human user type 1 is used by a living person who can access the network through an internet enabled device FIG. 1 20-29. A human user has one or more user roles such as: Follower 10, Competitor 11, Arbiter 12, Commissioner 13, Scout 14, Sponsor 15 or Annotator 16. Also Human users can have one or more dependents members such as: a Human 20, an Animal 21, a Plant 22, a Robot 23, a Vehicle 24, a Team 25 or a Tool 26.

An Organization user 2 can be used by any member of such organization to connect and perform operations in its name. An Organization user 2 can have one or more roles such as: Follower 10, Competitor 11, Arbiter 12, Commissioner 13, Scout 14, Sponsor 15 or Annotator 16. Also an Organization user 2 can have one or more dependent members such as: Humans 20, Animals 21, Plants 22, Robots 23, Vehicles 24, Teams 25 or Tools 26.

A Robot user 3 is an artificial intelligence that can be permanently logged to the network or can be connected for a limited time. Robot users can be programs or games that other users can challenge or compete against, or can be software attached to physical devices to compete in live events. Robot users 3 have limited roles such as: Competitor 11, Arbiter 12 or Annotator 16. Also Robot users can only have as dependent members other Robots 23, Vehicles 24 and Tools 26.

An Administrator user 4 is a special user who works for the company that runs the network. His task is to ensure data consistency, resolve technical problems and ensure all server infrastructure is functioning as planned. Also Administrator users 4 can resolve disputes between users and can take actions against any person, user, organization, activity or event that violates company rules or user agreements.

There are some regulations that govern user types, the roles and the type of dependent members they can have in the network: a) User can't be a Competitor 11 and an Arbiter 12 in the same event. b) A Robot user 3 can't have living beings as dependent members such as: Humans 20, Animals 21 or Plants 22.

Dependents members are those means the users use to compete along with or in their names, such as: Humans 20, Animals 21, Plants 22, Robots 23, Vehicles 24, Teams 25 or Tools 26. There are cases when users can become dependents of other users, e.g.: when a Human user 1 joins an Organization 2. Or when an Organization 2 builds a Robot. In that sense another example of dependent users can be a baseball team where all players have their Human user account 1, but also are dependents of an Organization 2 (the team) which is also dependent of a Coach who has another Human user account 1.

Human dependent members 20 are human beings who do not have a user account in the network. This dependent member type is designed for young humans like babies, people that do not know how to use internet connected devices FIG. 1 20-29 or those who don't want to be a direct member of the network. This type of member is also reserved for those humans that compete in the name of others.

Animal dependent members 21 are faunal living beings that are used to compete in the name or the users or alongside them.

Plant dependent members 22 are Floral living beings that are used to compete in the name or the users or alongside them.

Robot dependent members 23 are artificial intelligences that are attached to physical devices or are deployed in computer environments. Those intelligences can compete in the name of the users or alongside them.

Vehicle dependent members 24 are devices that can move themselves from one point to another. Those vehicles can be used by users to compete along with or in their name.

The Team dependent members 25 are groups of Vehicles 24, Robots 23, Animals 21 or Humans 20 that can be used by the users to compete in their name or alongside him.

The Tool dependent members 26 are those gadgets that users use to compete; a tool is a device that cannot compete by itself.

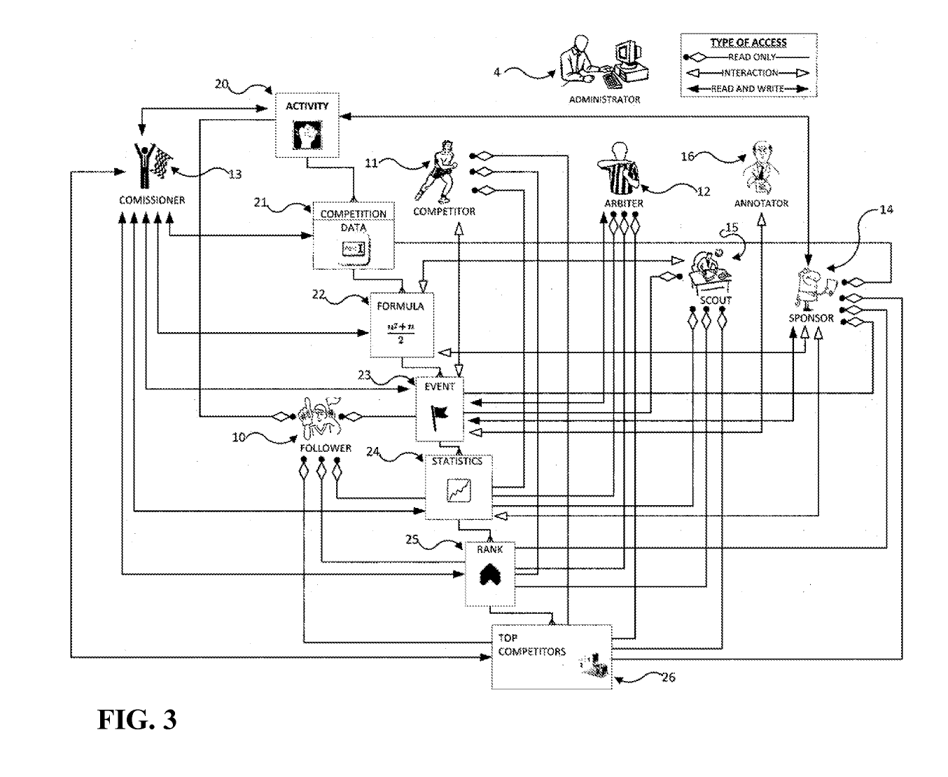

For the sake of comprehension from now on when describing a user using one user role to do an operation will be named by the Role as a type followed by the word “User”. e.g.: When Human user FIG. 2:1 uses the Commissioner role FIG. 3:13 to do an operation, it will be named as “Commissioner User”.

FIG. 3 is a conceptual diagram showing the main database entities and the access rights users can have according with their role. There are three main type of access:
a) Read only: users can only see the data the way it was predefined by users with the Commissioner 13 or Sponsor 14 user roles.
b) Interaction: users can enter data and do some operations. Those operations are governed by formulas and rules previously defined by other users with the Commissioner 13 or Sponsor 14 role.
c) Read and write: users can change data, rules or formulas.

Database entities 20-26 are those logically separated spaces in the memory of one or more database servers FIG. 1-33 that are designed to store data, formulas, rules and other definitions for future retrieval, calculus or to be used as a guide for one or more processes.

The Activity database entity 20 contains the main information about those topics in which competitors can compete in the network. Specifying main activity data is the first step of the competition process.

The Competition data database entity 21 contains the data types, validation rules, references to other data types and default values. This data definition defines what information can be stored in an activity and how it is validated.

The Formula database entity 22 contains instructions on how to calculate data stored on the Competition data entity 21. Those instructions can consist of: data grouping and summarization or mathematical or logical operations between elements of the Competition data database entity 21.

The event database entity is the repository for storing and retrieving activity data. Each occurrence of an Activity 20 is an Event 23. Therefore for each occurrences of an Event 23 all Activity 20 definitions, Competition data 20 definitions and calculation Formulas 22 are applied. All Events 23 conserve all definitions and formulas for each occurrence for data consistency, in that sense a change of Competition data 21 or Formula 22 won't affect past Events 23.

The Statistics database entity 24 is the result of calculations of the data stored on the Event 23 database entity and the application of one or more formulas stored in the Formula 22 database entity. This entity stores the results of those calculations to serve as a cache for the servers FIG. 1:30-32 reducing the wait time for other calculation operations.

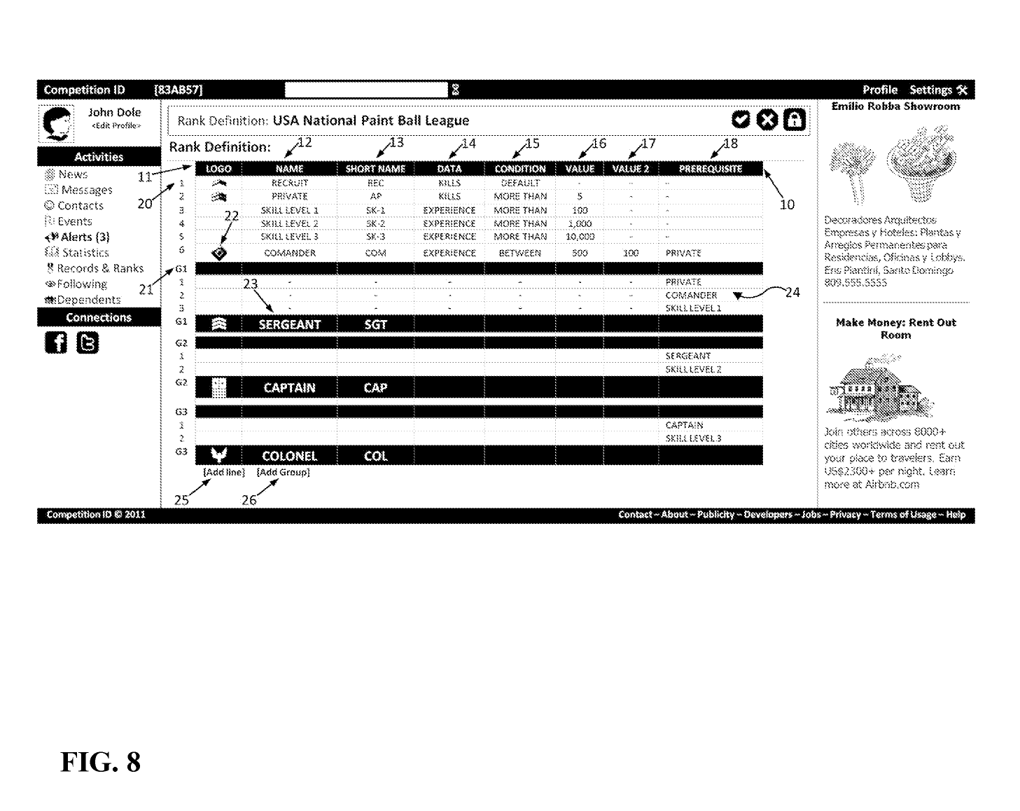

The Rank database entity 25 contains rules and formulas that are used to reward competitors with one or more distinctions when their statistics reaches some point or a rule is applied. Users FIG. 2:1-3 and Dependent members FIG. 2:20-26 can have one or more ranks FIG. 8. Also the Rank database entity 25 conserves each instance when a ranking rule is applied, in that manner previous ranks applied to users and dependents members can be preserved.

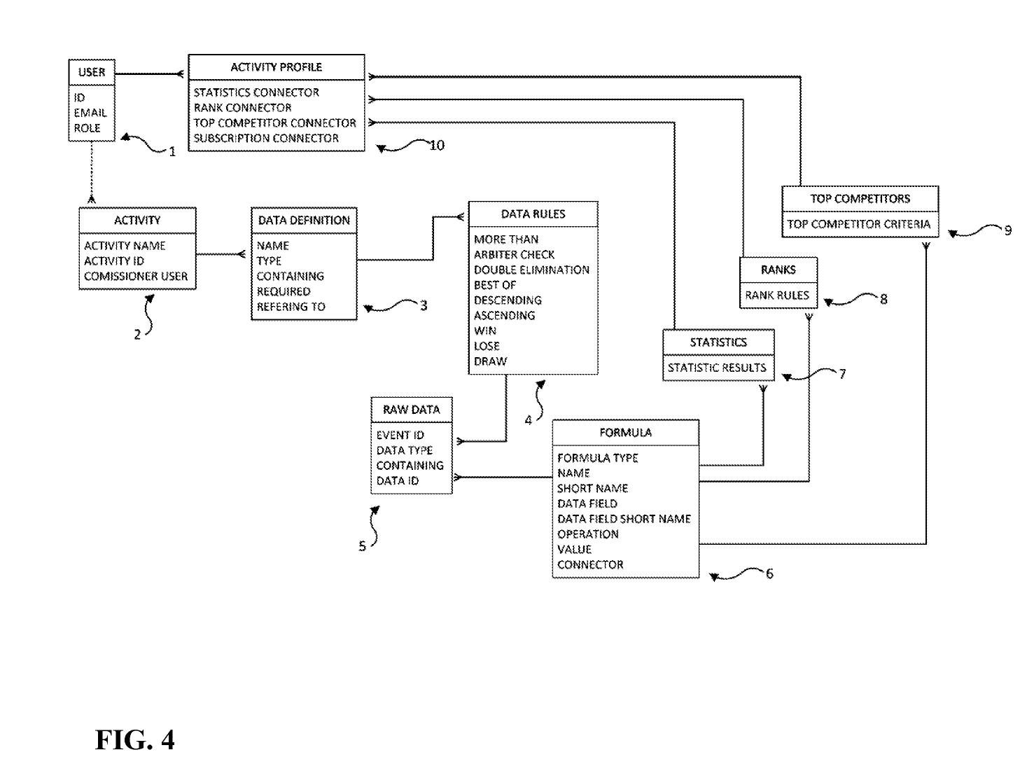

The top competitor database entity 26 contains rules to determine the best Competitors 11 of one or more Activities 20. Top competitors can show those awards as achievements in their generated profiles FIG. 4:10. Rules can be arranged in one or more time cycles so top competitors can be determined in a periodic way. Each time a top competitor is determined by the rules a new instance is created so Competitors 11 can retain their past awards.

Based on the definition of the database entities 20-26 and the type of access, the definition of the user roles 10-16 and the operations they can do on the network are as follows:

The Follower user role 10 is designed for noncompetitive tasks. This role allows a user to subscribe to one or more elements of the network and receive up to date information about those elements of his interest. A user with the Follower role 10 can:
a) Follow one or more Users FIG. 2:1-3 and view their Statistics 24, Ranks 25 and Top competitors 26 awards.
b) Follow one or more Activities 10 by viewing Statistics 24 of its Events 23.
c) Follow one or more Events 23 by viewing the Statistics and other data as they're produced.
d) Vote on polls and surveys to qualify any element of the network.

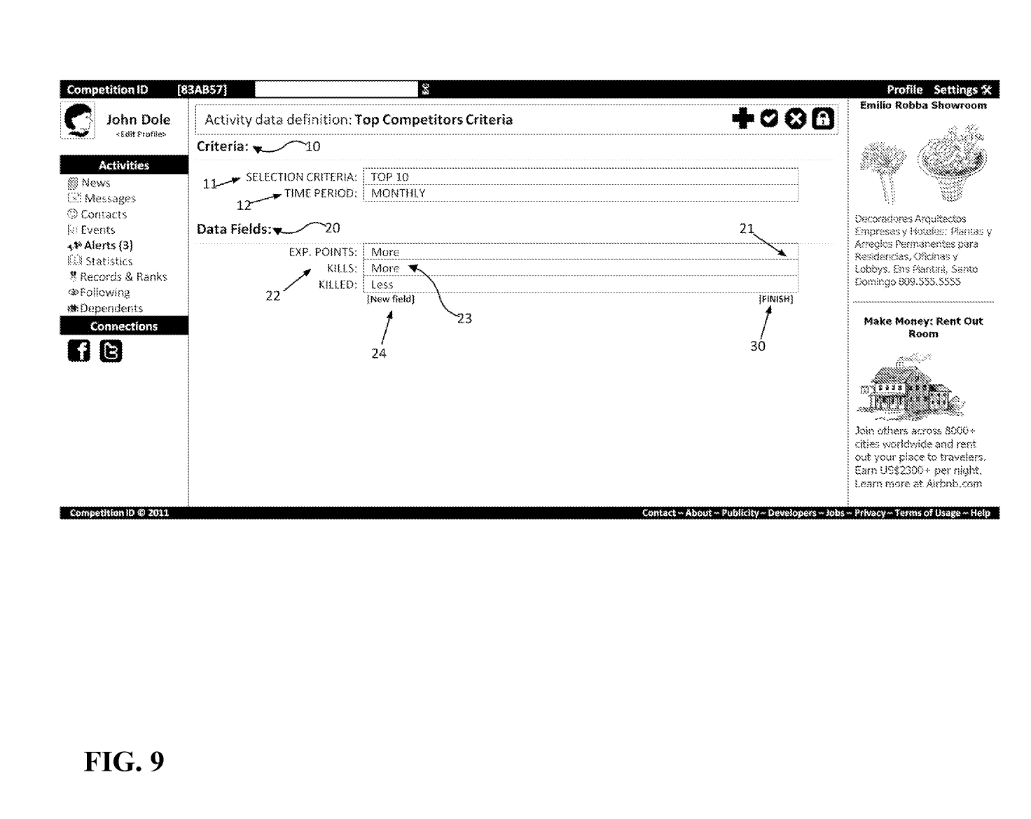

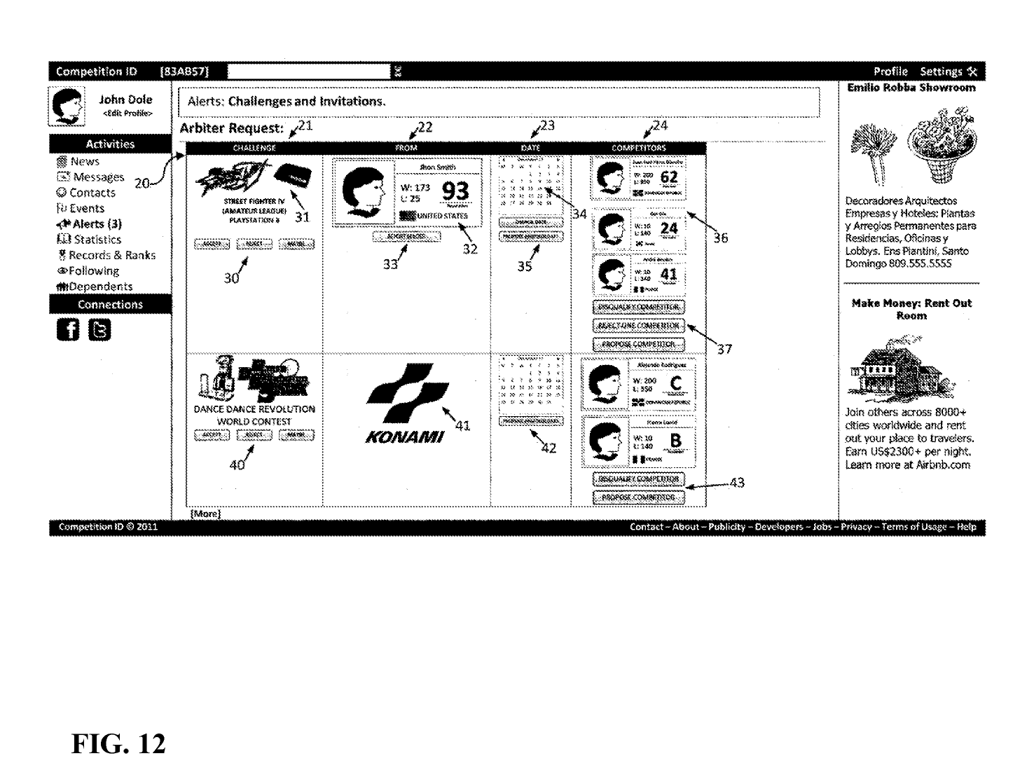

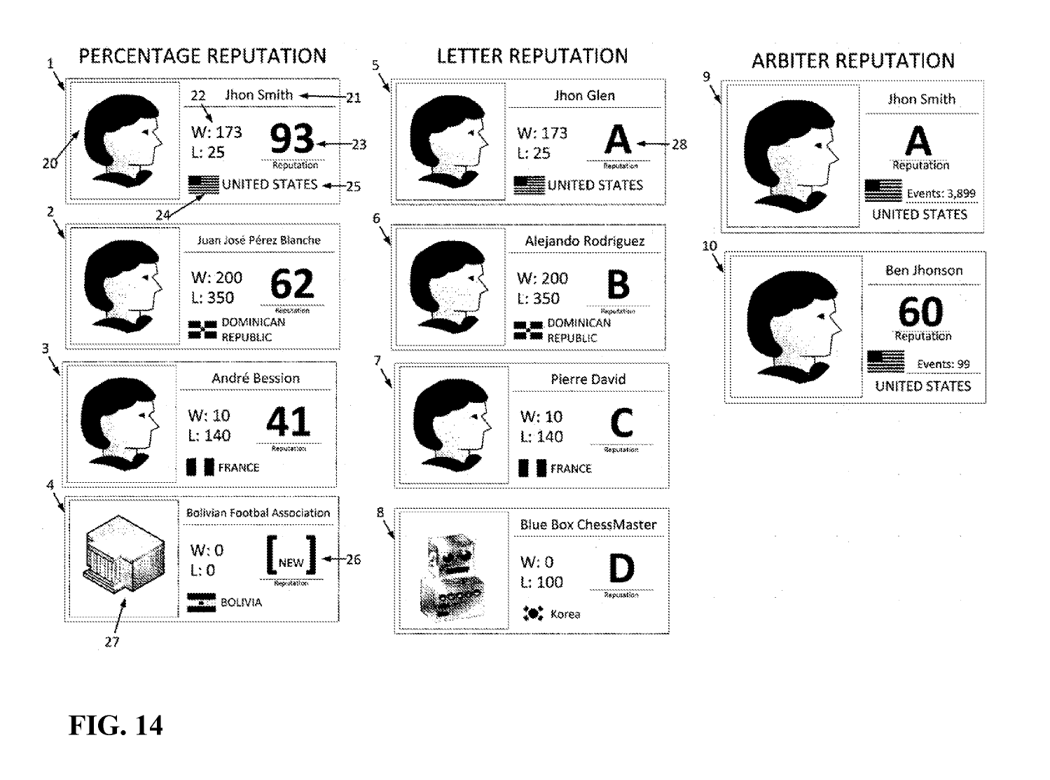

The Competitor role 11 is reserved for those users that compete in Events 23. Competitor users 11 have access to Events 23 by accepting “Challenge request” FIG. 9 from other users with roles of Competitor 11 or Commissioner 13. Users with this role can:
a) View Statistics 24 and Top Competitors 26 of an Activity he is invited to.
b) Send or accept Challenge requests
c) Propose or Reject an Arbiter 12 on an Event 23 he is invited to.
d) View Statistics 24 of Activities 20 and Events 23 he participated in.
e) Share with other users any Rank 25 or Top Competitor 26 award he has received.
f) Ask a Commissioner 13 or Arbiter user 12 to review, disqualify or cancel Events 23, other Arbiters 12 or Competitors 11.
g) Accept or reject requests of other users such as: Team, Challenge or Follow requests.
h) View ratings and reputation they have received by attending to Events FIG. 12, FIG. 14. Competitors 11 can receive Like/Dislike or 1 to 5 star ratings. Reputation is calculated according to a formula that can be defined by a Commissioner user 13.

The Arbiter user role 12 is designed for users that interact with the Event database entity 23 to enforce rules and certify its data. There is a restriction that prevents that users have the Competitor 11 and Arbiter 12 role in the same Event instance, only Robot users FIG. 2:3 can have both Competitor 11 and Arbiter 12 user roles in the same Event instance 23.

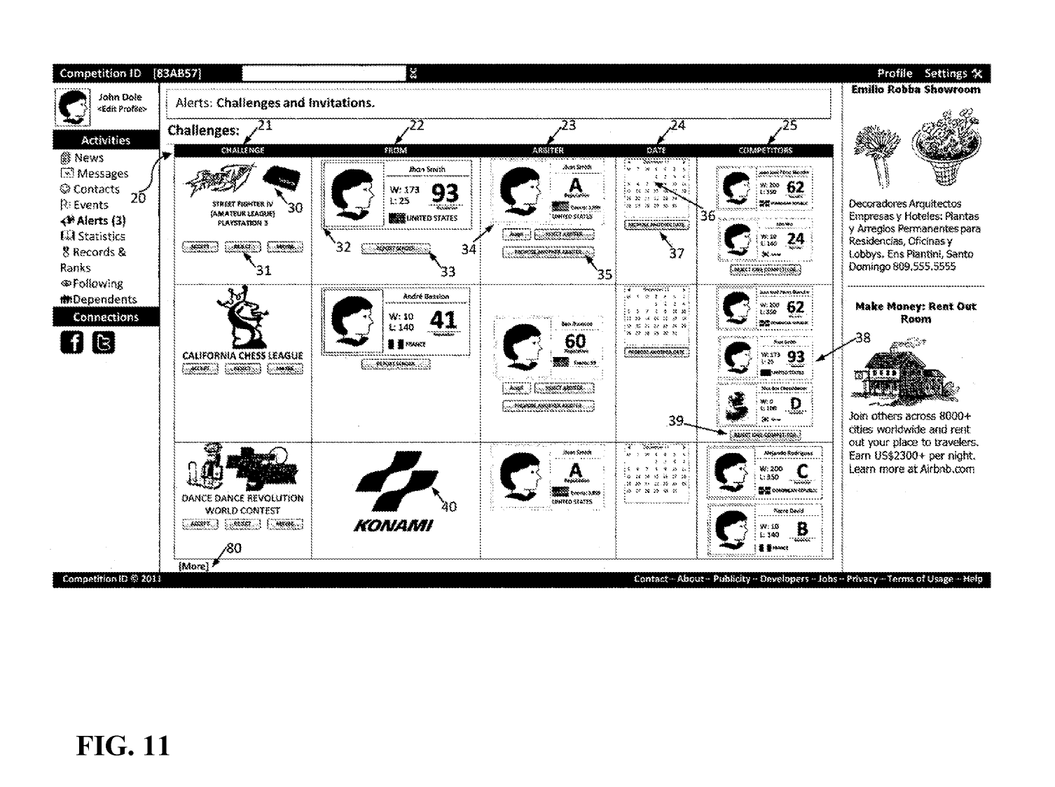

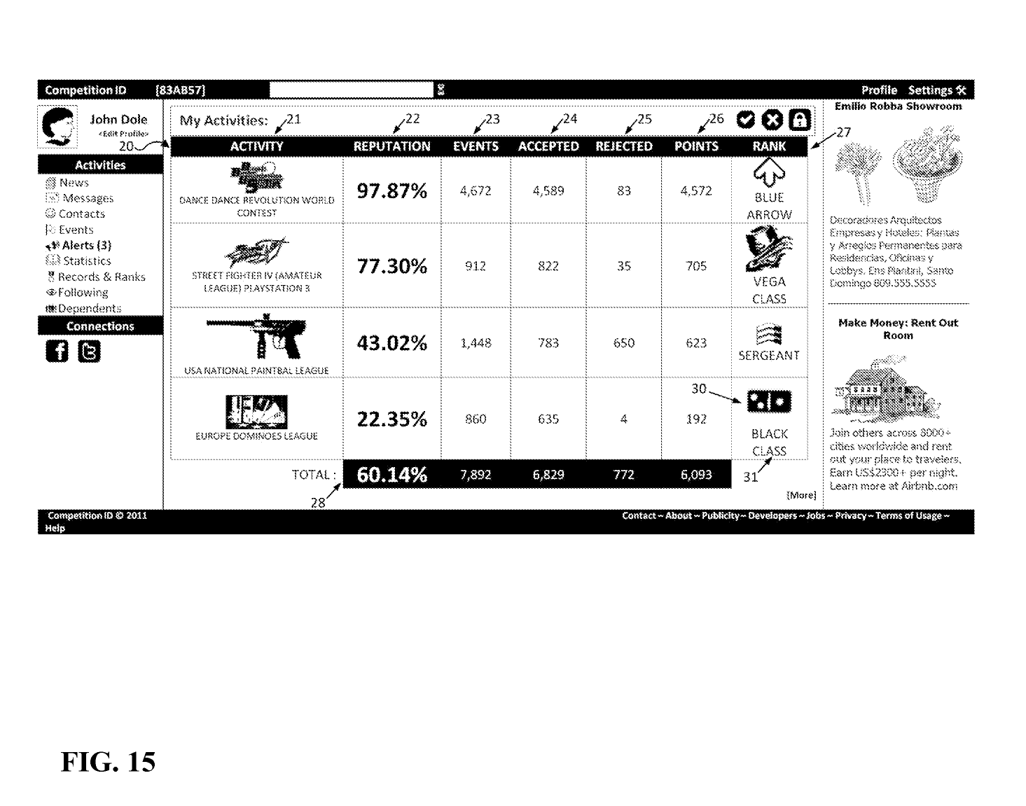

The Arbiter 12 user role can be temporarily assigned to a user if he is chosen by others Competitors 11 that want to compete between them; in that case an Arbiter request FIG. 11 is sent to the user. After accepting the Arbiter request FIG. 11 to judge an Event 23 users with the Arbiter role 12 can:
a) Approve and certify the data capture in an Event 23 instance.
b) Disqualify Competitors 11 and specific data.
c) Reschedule, cancel or postpone an Event 23.
d) View general information of the Activity 20 that an Event 23 belongs.
e) Review Competition data 21, Formulas 22 and other rules that govern the Event 23.
f) View Statistics 24 of all Competitors 11 attending to the Event 23.
g) View profiles of all Competitors 11 attending to the Event 23 and the Dependent members FIG. 2:20-26 they will use if any.
f) View the qualifications he received by attending to the Event 23 and his Reputation FIG. 15. Arbiters can receive Like, Dislike or 1 to 5 star qualifications.

The Commissioner User role 13 is the highest role; a Commissioner user can govern all aspect of an Activity 20, and all instances of Competition data 21, Formula 22, Event 23, Statistics 24, Rank 25 and Top Competitors 26 that belongs to it. This role is obtained when a User FIG. 2:1-3 creates an Activity 20, or when a Sponsor user 14 passes him full control of an Activity 20 he created. A user with the Commissioner User role can:
a) Create or change competition Activities 20 with all related database instances 21-26.
b) Accept “Commissioner Requests” from one or more Sponsor users 14 to manage an Activity 20 they created.
c) Define or change Competition data 21, Formulas 22, Rank systems 25 and Top Competitor Criteria 26 at any time.
d) Deactivate Event 23 instances, when this happens all users attending those events lose all data related to those events and statistics are recalculated.
e) Send invitations to other users to subscribe to the Activity 20 he is in charge of.
f) Accept or approve subscriptions to the Activity 20 he is in charge.
g) When attending to an event a Commissioner 13 can have all functions of an Arbiter user 12 if he is not competing in the same event.
h) Disqualify one or more Arbiters 12 and solve disputes by attending to “Dispute request” from users subscribed to his Activity 20.
i) Close his Activity 20. When this happens all data and achievements remain and the statistics and awards Competitors 11 received remain on their profiles.
j) Transfer his role to other user in case he decided not to support the Activity 20 he created anymore.

The Sponsor user role 14 is designed for those users FIG. 2:1-3 who want to create and promote competition activities related to their brand or name. Sponsor users 14 can create Activities 20 with all related database entities 21-26 and later transfer administrative rights to other users. Sponsor users 14 can retain some rights over the Activities 20 they created such as invite to Events 23 or managing Formulas 22 to view Statistics 24 the way he wants. A user with the Sponsor role can:
a) Create a competition Activity 20 with all related database entities 21-26 to later transfer administrative functions to another user.
b) View all database entities and instances 21-26 related to the Activity 20 he created.
c) Define and Apply his own Formulas 22 to view the data of the Activity 20 he created the way he wants.
d) Schedule, reschedule, postpone or cancel Events 23 belonging to the Activity 20 he created.
e) View Ranks 25 and Top Competitors 26 awards of the Activity 20 he created.
f) Send Challenge requests FIG. 9 to other Users FIG. 2:1-3 asking them to participate on one or more Events 23 of the Activity 20 he created.

The Scout user role 15 is reserved for users who want to find talented Competitors 11 or other users with special conditions of their interest. Scout users 15 do not compete in Events 23. Scout users must be accepted by Commissioners or Sponsor users to see the data of an Activity 20. After being accepted in an activity users with the Scout user role can:
a) Define or apply his own Formulas 22 to see the Statistics 24 of an Activity 20 the way he wants.
b) View Ranks 25 and Top Competitors 26 awards of an Activity 20.

The Annotator user role 16 is designed for users that capture or enter data to the Events 23. Data entered by Annotator users 16 is marked as “unofficial” until it is certified by an Arbiter 12 or Commissioner 13 user, Users with the Annotator user role 16 can:
a) Interact with the Event 23 database entity to enter the data. All data entered in the event instance is validated according to the rules of the Competition Data 21 database entity.
b) View statistics of the Event 10 they're annotating.

All database entities 20-26, User roles 10-16 and any other operation are monitored and regulated by one or more Administrator users 4 to enforce policies and solve disputes.

FIG. 4 is a block diagram showing a detailed description of database entities and the necessary steps to produce a generated user profile. The diagram shows several database entities 1-10 connected by one to many relationships. A database entity can be allocated on one or more physical database servers FIG. 1:23 and can comprise of one or more tables managed by relational or non-relational database engines.

Therefore database entities with few changes over time like the User 1 or Activity 2 can be normalized and managed by relational database engines. On the other hand Data Definition 3, Data Rules 4, Raw Data 5, Formulas 6, Statistics 7, Ranks 8 and Top Competitors 9 are more likely to be stored in XML language because their semi structured schema. Those database entities are more likely to be managed by one or more No-SQL database engines.

In the User database entity 1 only basic user data is kept such as email, Internal ID or user roles. This entity does not contain any information that could lead to contact the user directly except the email. Other personal information such as name or address can be entered by the user when subscribing to an Activity only if this data is required to subscribe. Commissioner FIG. 3:13 or Sponsor FIG. 3:14 users can declare this information as required when defining the data types in the Competition Data FIG. 3:21 database entity.

When a user decides to leave the network only the email data entry is deleted from the User database entity 1 leaving the ID and user roles intact for data consistency purposes. Also when this situation occurs all personal data that the user entered in all activities is substituted by the word “Deactivated user” or “Deactivated profile”.

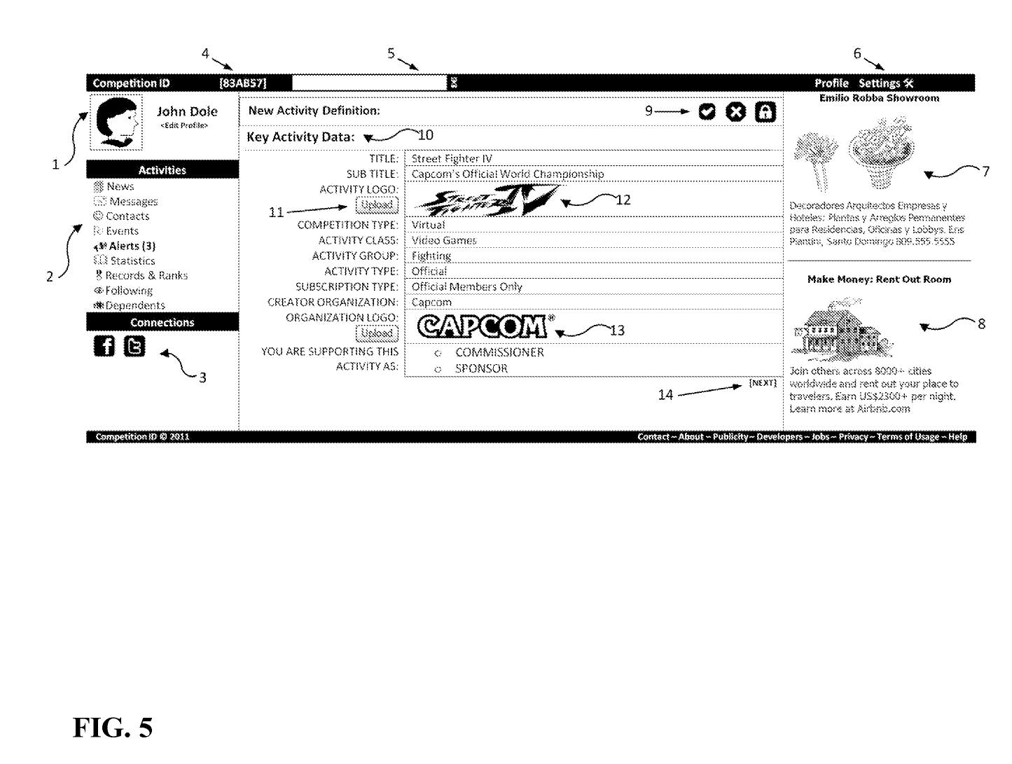

The Activity database entity 2 is the grand parent of all related data in the network and connects a user with all data generated on each entry or instance. General information about the Activity can be specified here, such as: Title, Subtitle, Activity logo, Company logo or Activity class. Contents on this entity can be created or filled when a Commissioner FIG. 3:13 or Sponsor FIG. 3:14 user creates an Activity FIG. 3:20-FIG. 5.

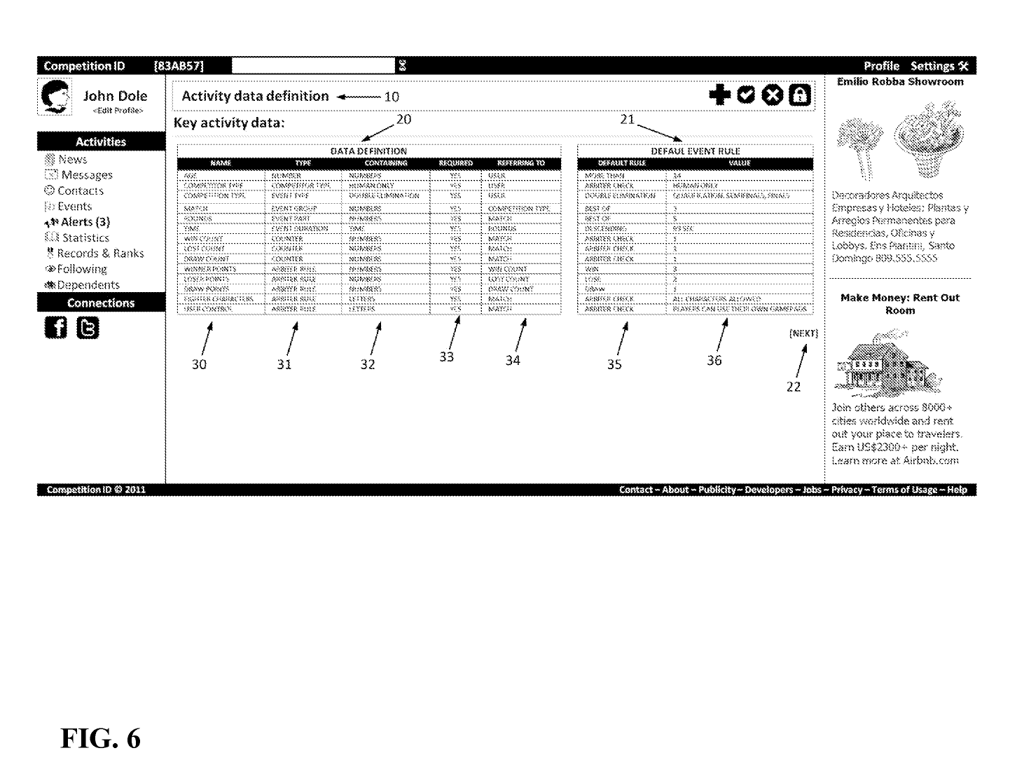

The Data Definition database entity 3 contains general specifications about the data that can be stored such as: Data name or Data type. This entity also contains general rules about the type of information that can be stored such as Numbers, Letters, or if a data entry is required to have a value. Contents on this entity can be created or filled when a Commissioner FIG. 3:13 or Sponsor FIG. 3:14 user defines Activity Competition Data FIG. 3:21-FIG. 6.

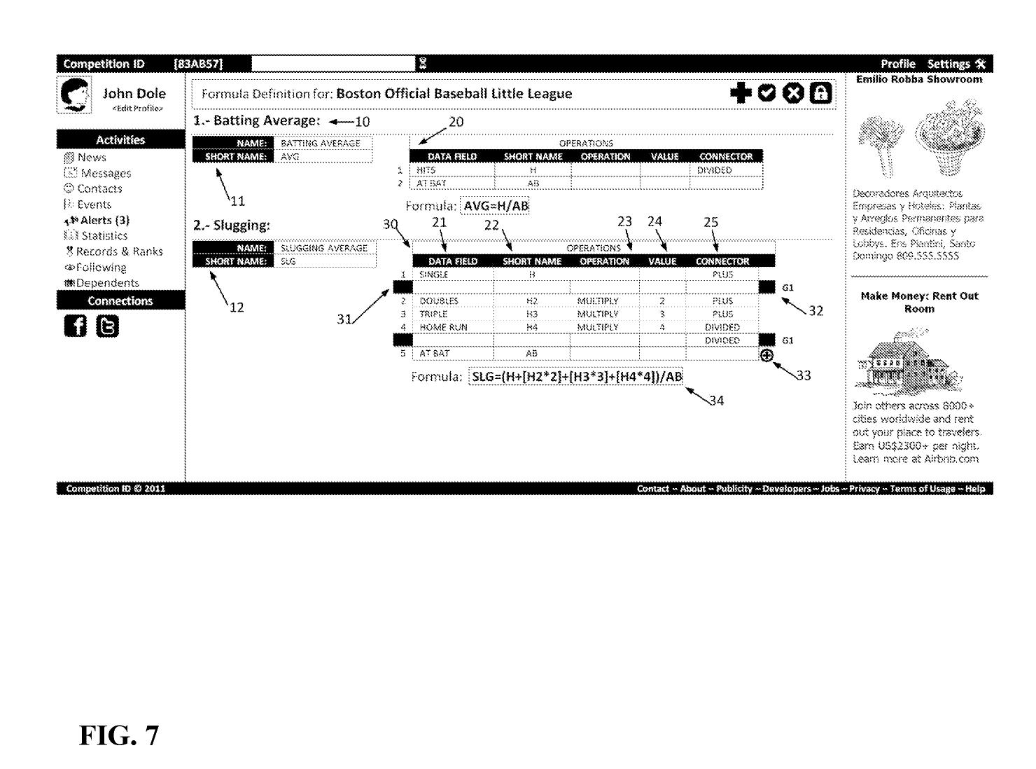

The Data Rules database entity 4 contains one or more set of rules that must be validated when entering data in an Event FIG. 3:23. This set of rules may vary from one event to another and can be applied to one or more data entries of the Raw Data database entity 5 to validate and ensure rules that the Commissioner FIG. 3:13 or Sponsor FIG. 3:14 have set. Contents on this entity can be created or filled when a Commissioner FIG. 3:13 or Sponsor FIG. 3:14 user defines one or more Formulas FIG. 3:22-FIG. 7 of an Activity FIG. 3:20.

The Raw Data database entity 5 is the primary source for all data calculations by containing special fields to link the data with Event Occurrences FIG. 3:23 to ensure data consistency. Each time a data is entered in an Event FIG. 3:23 an entry in the Raw Data database entity is created, and then is validated with the rules defined on the Data Definition 3 and Data Rules 4 database entities. Contents of this database entity are created or filled when an Annotator user FIG. 3:16 enters the data in the name of the Competitor FIG. 3:11 that is attending to an Event FIG. 3:23.

The Formula database entity 6 contains the necessary calculation steps and connection specifications between data elements to produce one or more Statistics 7. Contents on this entity can be created or filled when a Commissioner FIG. 3:13 or Sponsor FIG. 3:14 user defines a Competition Activity formula FIG. 3:22-FIG. 7.

The Statistics database entity 7 contains the results of one or more Formulas 6 grouped by Activity 2. Contents of this database entity are generated automatically in time periods regulated by Administrator users FIG. 3:4 to ensure the high availability of completion results.

The Ranks database entity 8 contains a set of awards that users can get and the rules they must meet in order to receive those distinctions. Awards definitions in this entity can contain either letters or graphics. Contents on this entity can be created or filled when a Commissioner FIG. 3:13 or Sponsor FIG. 3:14 user defines the Awards or ranks Competitor users FIG. 3:11 can receive when competing in their Activity FIG. 3:25-FIG. 8.

The Top Competitors database entity 9 contains rules for calculating and selecting the best competitors of an Activity 2. Data for this calculation and selection criteria are taken from the Statistics database entity 7. A time frame can be defined by Commissioner FIG. 3:13 or Sponsor FIG. 3:14 users to recalculate the best players of their activity within that time. In that manner the best Competitors of an Activity FIG. 3:20 can be shown by period of time such as: hourly, daily, weekly, monthly or yearly.

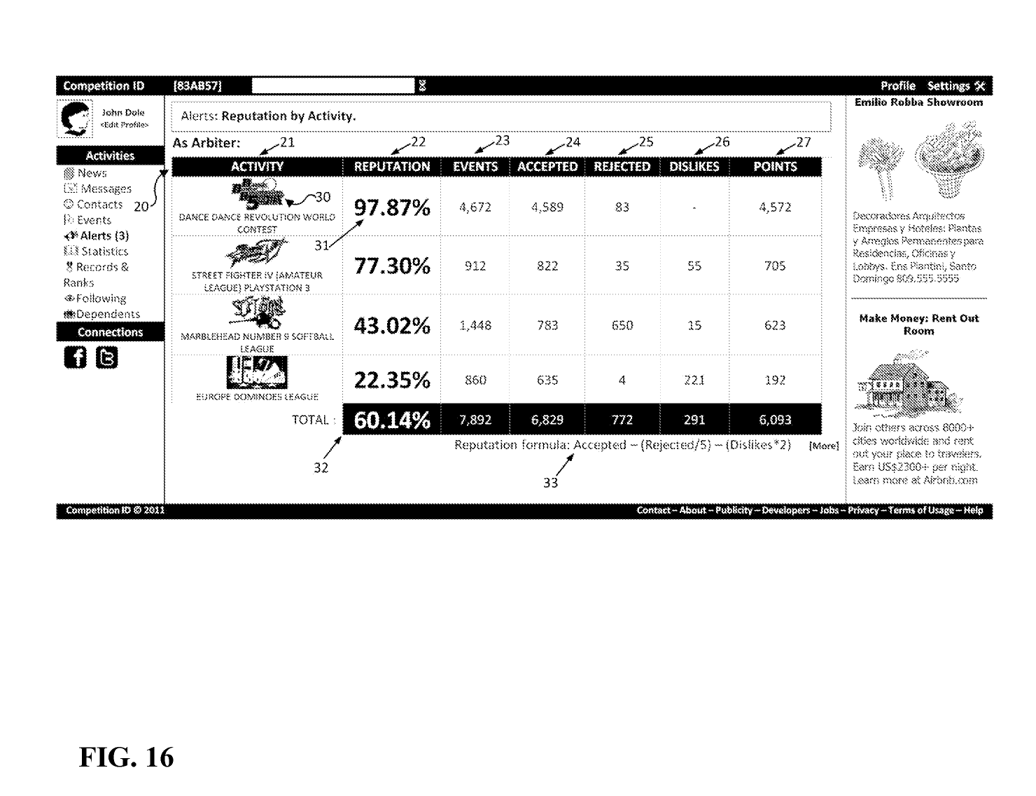

The Activity Profile database entity 10 contains on demand results from the Statistics 7, Ranks 8 and Top Competitors 9 database entities. Results stored on this database entity may vary each time a user logs into the network and his profile is shown or when internal database calculations are made. A User FIG. 2:1-3 can have multiple Statistics 7, Ranks 8 or Top Competitor 9 results from one or more Activities 2. In this manner the Activity Profile database entity 10 provides a centralized way for Users FIG. 2:1-3 to see all results for one or more competition Activities 2. FIG. 14, FIG. 15, FIG. 16.

Other database entities are used for internal operations such as: activity linking, user security, account restoration, chat sessions, sending and accepting requests, COPPA rules or cache operations. Those database entities were not shown because they're not needed to comprehend the invention.

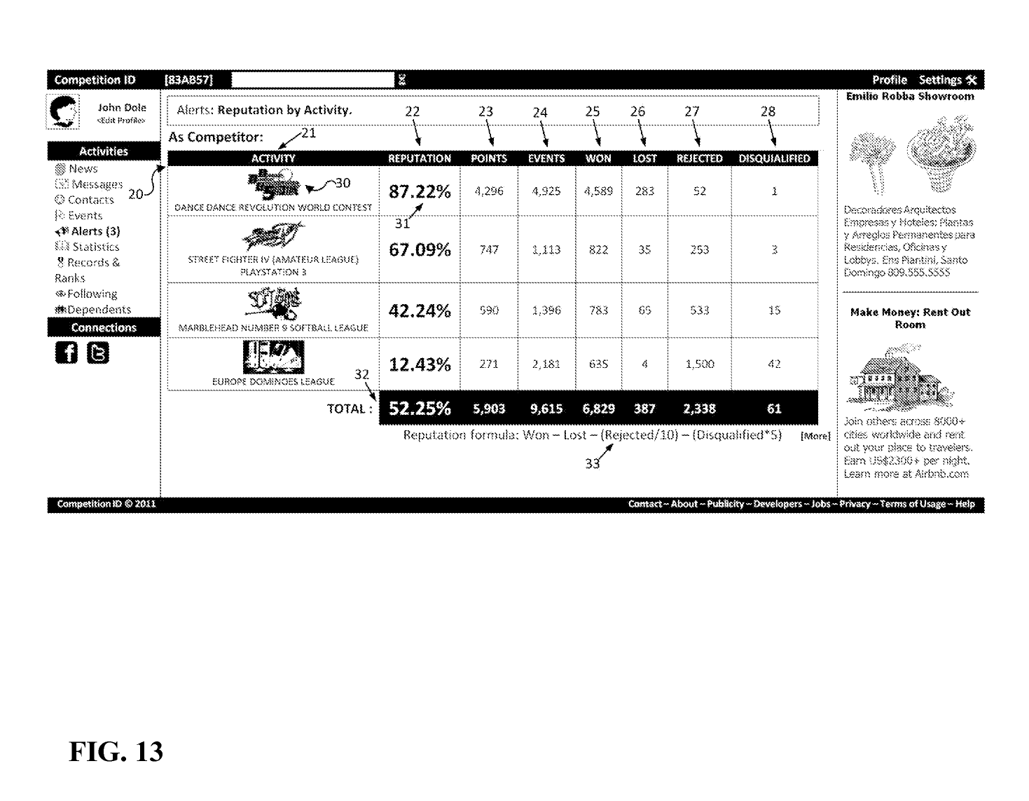

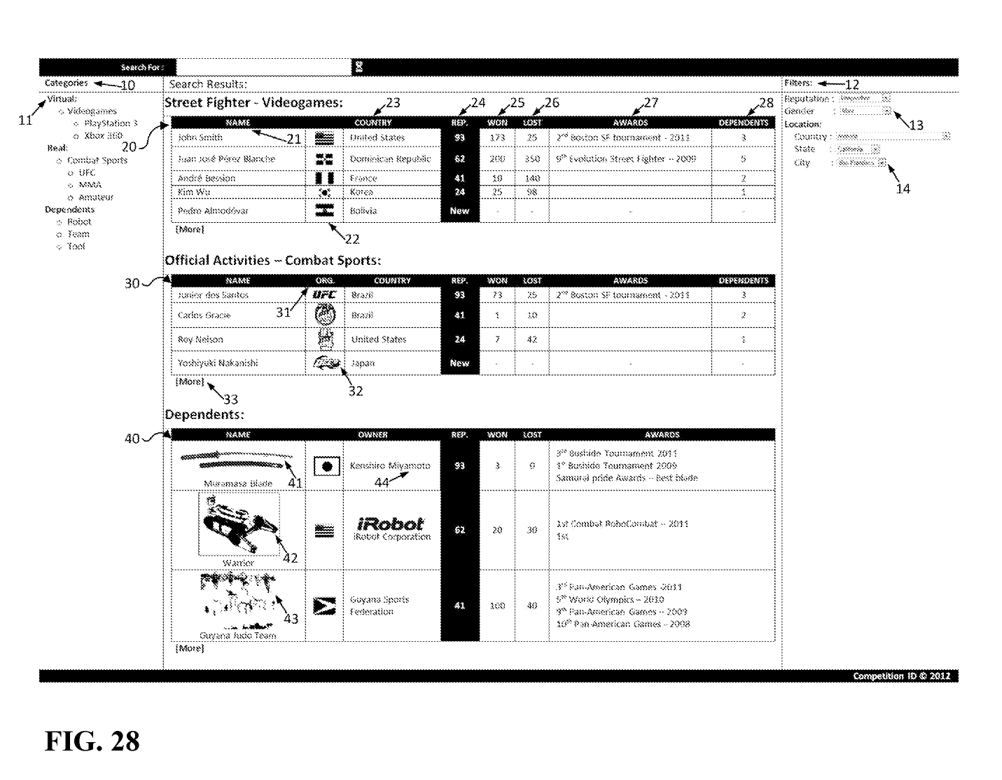

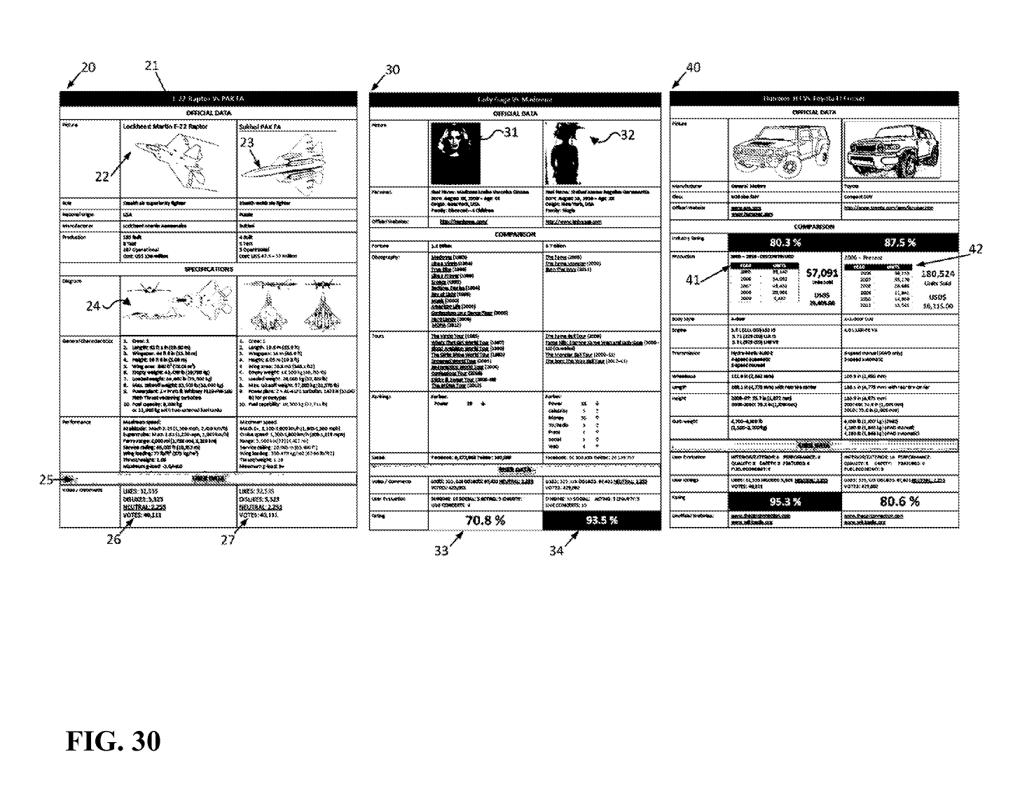

From FIG. 5 to FIG. 30 with the exception of FIG. 13, FIG. 28 and FIG. 30 they are examples dynamically generated user profiles. Those user profiles have common areas, icons and operations. Those areas are defined as follows:

The user identification section 1 can be conformed of a picture, the nickname or real name and a link that takes the user to modify his main profile data.

The activities section 2 can be conformed of icons and text hyperlinks that the user can use to go to other sections of his profile or to perform operations according to his user role FIG. 3:10-16.

The connection section 3 shows the subscriptions the user has to share his statistics or achievements on social networks.

The outer frame 4 at the top line shows the name of the site, the generated internal ID of the user. Also the outer frame 4 shows at the bottom line the copyright information and other text or graphic hyperlinks that are managed by the company that runs the network.

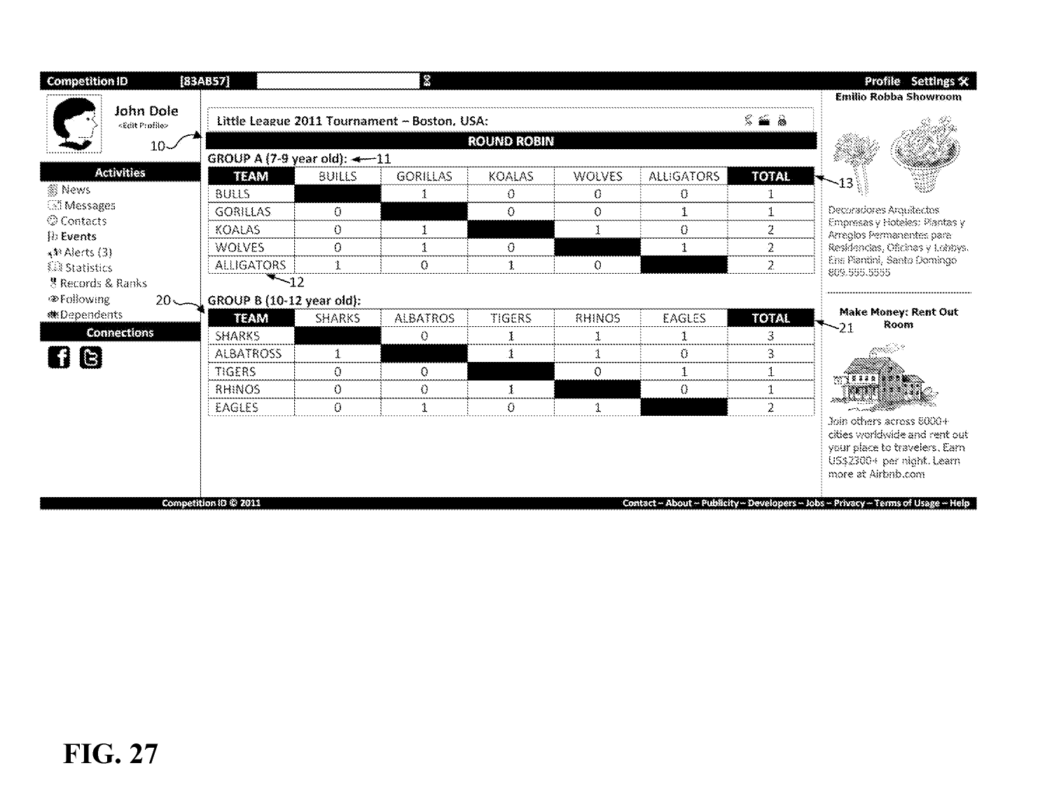

The search bar section 5 can take the user to the search section FIG. 27 to find topics of his interest or to Challenge other users FIG. 9 if he wants to compete.

Profiles Settings section 6 take the user to an administrative section where he can change his privacy settings, manage subscriptions or deactivate his account.

Advertisement sections 7 and 8 are shown based on operations the user is doing or where he is going on the network. Those advertisements are managed by the company that runs the network.

Operation icons 9 are graphic representations of status or operations about a profile section the user is visiting. This section can have one or more icons.

When representing one or more status, those icons can be:
a) Chain: representing a link to other section of the network
b) Film slate: representing a video link
c) Padlock: indicating that the data shown is locked and cannot be changed.

When representing one or more operations, those icons can be:
a) Plus sign: indicating that when pressed a new element will be added.
b) Check Mark: indicating that when pressed data wil be saved.
c) X sign: indicating that when pressed all new edits will be discarded.
d) Padlock: indicating that when pressed all new edits will be disallowed.

Other examples of dynamically generated user profiles screens such as: Activity subscription, Dispute request, contact management, profile preferences or login section where not included because they are not needed to comprehend the invention.

FIG. 5 shows the first step of an activity definition process: the main data definition process by a Commissioner FIG. 3:13 or Sponsor User FIG. 3:14. The key activity data section 10 contains the fields and definitions that will identify the activity in the network. This information is stored in the Activity database entity FIG. 4:2.

Activity definition fields can be comprised of:
a) Title: is the primary text line which will be shown as the main identification of the activity in the network.
b) Subtitle: a second line which shows more information about the activity.
c) Activity logo 12: is a graphical representation of the activity that the user can upload by pressing the Upload button 11. The uploaded picture or graphic will be shown along with the Title of the Activity in the network.
d) Competition type: defines the environment where the activity takes place: the user can choose “Live” it if take place on a physical environment or “Virtual” if the activity takes place in cyberspace or a computer generated environment.
f) Activity class: is an internal classification of the activity made by the company that runs the network, the user can create a new class if he wants.
g) Activity group: is an internal sub classification of the activities made by the company that runs the network, the user can create an Activity group if he wants.
h) Activity type: Defines if the activity is managed by an organization and if their results will be marked as “Official” in Competitors user profiles FIG. 16.
i) Subscription type: governs which type of competitors can join an activity, in this case only members the organization can join the activity.
j) Organization logo 13: is the graphical representation of the organization to which the activity belongs.

The “NEXT” text hyperlink when pressed will take the user to the next step of the activity definition: the Activity data definition section FIG. 6.

FIG. 6 shows the second step in an activity definition process: two tables on the screen are used for the Activity data definition: The data definition table 20 and the Default event rule table 21. Entries on both tables are stored in the Data definition database entity FIG. 4:3. Predefined attributes in conjunction with other fields that the user must fill can be used to create a data definition.

Definitions in the Data Definitions table 20 can be made by filling the following columns:
a) Name 30: here the user can name each data definition by typing any name.
b) Type 31: predefined data types can be specified to define the behavior of each data definition such as:
   1) Number: Only numbers are allowed.
   2) Competitor type: defines what kind of users can compete in the activity FIG. 2:1-3
   3) Event group: Defines a container for one or more events.
   4) Event part: Defines a member event for an event container
   5) Event duration: defines a time period in which the event should take place and a top limit in which the event should end.
   6) Counter: Defines a numeric container to store the result of a sequence of addition or subtraction of numeric values.
   7) Arbiter rule: Indicates a value, data or operation that one or more Arbiters users FIG. 3:12 must enforce when judging an Event FIG. 3:23.
c) Containing 32: predefined containers can be specified to define what kind of information a data definition can store such as:
   1) Numbers: Only numbers are allowed
   2) Human Only: Only Human users are allowed FIG. 2:1.
   3) Double elimination: Indicate that attending Competitors FIG. 3:11 to an Event FIG. 3:23 must lose twice to be defeated.
   4) Time: A numeric value representing time intervals.
   5) Letters: Only alphanumeric characters are allowed.
d) Required 33: indicates if a data definition is required or can be omitted.
e) Referring to 34: indicates if the current definition is applied as a rule to a previously defined definition. The name of the data definition 30 can be specified on each row or predefined referenced data types can be specified such as:
   a) User: Rule is applied to the user FIG. 2:1-3.
   b) Event: rule is applied to the event FIG. 3:23.
f) Default rules and values can be defined on each Definition data by adding values on both the Default rule 35 and the Value 36 columns such as:
   a) More than: A value or quantity must be higher than a given amount or quantity.
   b) Arbiter Check: Indicates that the arbiter must manually check or verify a rule.
   c) Best of: Evaluates several win/lost counts of a series of events to determine the winner, the amount of events are usually odd numbers.
   f) Descending: indicates a descending order for a time data type.
   g) Ascending: indicates an ascending order for a time data type.
   h) Win: Defines which reward, point or punishment the competitor will receive for wining.
   f) Lose: Defines which reward, point or punishment the competitor will receive for losing.
   f) Draw: Defines which reward, point or punishment all competitors will receive when ending tied in an event.

Therefore by analyzing the data definition 20 and the Default event rule 21 tables we can conclude that all Event instances FIG. 3:23 of this activity FIG. 3:20 will have the following behavior:
a) Configuration: A double elimination tournament, judging the best of 3 matches off five rounds of 99 sec. The event is divided into three parts: Qualification, Semifinals and Finals.
b) Restrictions: only humans 14 or older are accepted.
c) Points and rewards: win, lose and draw counts valued as 1 and are granted by Arbiters FIG. 3:12. Competitors can gain points for participating such as: 3 when winning, 2 when losing and 1 when tying.
d) Rules: All characters are allowed and Competitors FIG. 3:11 called “Players” in the event can use their own gamepads.

FIG. 7 shows the third step in an activity definition process: The formula definition. Here the user can define formulas that will be used to calculate statistics FIG. 3:24. Definitions on this step are stored in the Formula database entity FIG. 4:6.

One or more formulas are defined by adding a Primary definition comprising of a Title 10 plus Name and Short name 11, 12. Then calculation steps and parts can be added on an operations table 20, 30 comprising of the following column definitions:
a) Data Field 21: containing the data field that will be the source of the calculation. The fields that the user can choose in this column correspond to the field defined in the Competition data FIG. 3:21 database instance.
b) Short name 22: containing an abbreviation for the name
c) Operation 23: containing a name for the mathematical operation that will be performed with the field such as: Add, Subtract, Multiply, Divide or Power.
d) Value 24: containing an arbitrary value added by the user.
e) Connector 25: containing the name of a mathematical operation that will also serve as a connector to another line or group of operations 31, 32.

At the bottom of each Operations table 20, 30 a result formula field is shown. Users can also specify the formula by typing onto this field, the Operations table 20, 30 then will be filled with lines after this field is validated. Users can either add a line or a group by pressing the Plus icon 33, then group indicators 31, 32 marks the beginning and end of each group.

All field choices on Operations tables correspond to Data types and definitions of the Data Definition database entity FIG. 4:3 to make sure the user is applying formulas to previously defined data. Some validation rules are applied to make sure the user is not applying wrong operations to the data defined like multiplying an alphanumeric data definition.

FIG. 8 shows the fourth step in an Activity definition process: the Ranks definition. The Rules to define ranks are stored in the Ranks database entity FIG. 4:8. All database fields and specifications are taken from the Data Definition database entity FIG. 4:3 to avoid users referring to invalid data.

Ranks definitions are made by adding Lines 20 or Groups 21 to the Ranks definition table 10 containing the following column references:
a) Logo 11: a graphical representation of the rank or award 22.
b) Name 12: a name that the user can assign by typing directly to the cell.
c) Short name 13: an abbreviation the user can specify by typing directly to the cell.
d) Data 14: A field from the Data definition database entity FIG. 4:3 that will be used to calculate the rank or award.
e) Condition 15: a rule or calculation used to determine the rank or award, such as:
   1) Default: applied when no other value exist.
   2) More than: applied when the data passes a specified numeric value.
   3) Between: applied when the data is in between two numeric values specified in Value 1 16 and Value 2 17 columns.
f) Value 1 16: containing the first value to be used to evaluate the Condition 15.
g) Value 2 17: containing the second value to be used to evaluate the Condition 15.
f) Prerequisite 18: indicate if a rank from a previous line is also required.

Group definitions 21 can be added to apply a rank or award which requires more than one line of specification. Users can add a group by pressing the “Add group” link 26. Group definitions are marked by highlighted lines 23 and can contain lines of definitions or links to previous definitions 24 to apply all of them as a whole.

Therefore by analyzing the FIG. 8 we can determine that the following ranks will be applied to competitors or “players” of a Paint ball activity:
a) Recruit: when the player joins the activity and has no data.
b) Private: when he has more than 5 kills
c) Skill level 1: when his experience is more than 100 points
d) Skill level 2: when his experience is more than 1,000 points
e) Skill level 3: when his experience is more than 10,000 points
f) Commander: when his experience is between 100 and 500 points
g) Sergeant: when he is a private and a commander and has skill level 1.
h) Captain: when he is a Sergeant and has Skill level 2.
i) Colonel: when he is a Captain and has Skill level 3.

When participating on this activity, a player with 12 kills and 754 experience points is awarded with the following awards: Private, Skill Level 1, Commander and Sergeant.

FIG. 9 shows the last step in an activity definition process: the Top Competitors criteria definition. Top competitor criteria definitions are stored in the Top Competitors database entity FIG. 4:9. Users can specify Top competitors rules by specifying the Criteria 10 and the relevant Data fields 20 to be taken into account.

The Selection criteria 11 has pre-defined selection rules such as:
a) Top 100: Only the best 100 competitors are awarded
b) Top 10: Only the best 10 competitors are awarded
c) Top 5: Only the best 5 competitors are awarded
d) Top 3: Only the best 3 competitors are awarded
e) Ladder: When a competitor lose in an event, he changes the position with the other, if he wins he goes up one position.
f) Sequential Ladder: When a competitor loses in an event, he goes down one position. If he wins goes up one position

When defining Data fields 20 that will be used to choose the best competitors of an activity, the user can add them using the “New field” link 24. All fields that can be specified 22 in the Specification fields table 21 correspond to those defined in the Data definition database entity FIG. 4:3. After a field is specified 22 in the table, a Rule 23 can be defined for that field such as:
a) More: The competitor with the higher quantity is taken into account
b) Less: The competitor with the lower quantity is taken into account.
c) Title: The competitor with a predefined alphanumeric value is taken into account.

Therefore by analyzing this criteria we can conclude that for this example of a “Paint ball” activity the best competitors or “Players” will be those with most experience points and kills, but with less times being killed by other players.

When the user presses the “FINISH” link 30 the process of creating an activity is concluded and the activity is ready. At this point a Sponsor user FIG. 3:14 can pass the administration of the activity to a Commissioner user FIG. 3:13.

In an internet competition network interpersonal relationship are established by the interaction of the users in relation to the activities they belong to. That way real live relationships are recreated such as:
a) Teammate: designed for all members of the same team. Once a user joins a team, he and all other members are related with this relationship. Once the user leaves a team this relationship is lost.
b) Mentor: Designed for leaders and other staff members. Once a member joins a team, all mentors of the team become his mentor.
c) Colleague: Designed for Mentors belonging that support the same team or belong to a common organization. Once a mentor joins an organization, all mentors becomes his colleagues.
e) Opponent: A temporary relationship designed for all competitors FIG. 3:11 that compete against each other for the duration of an Event FIG. 3:23.
d) Rival: Designed for users that compete against each other on a regular basis.

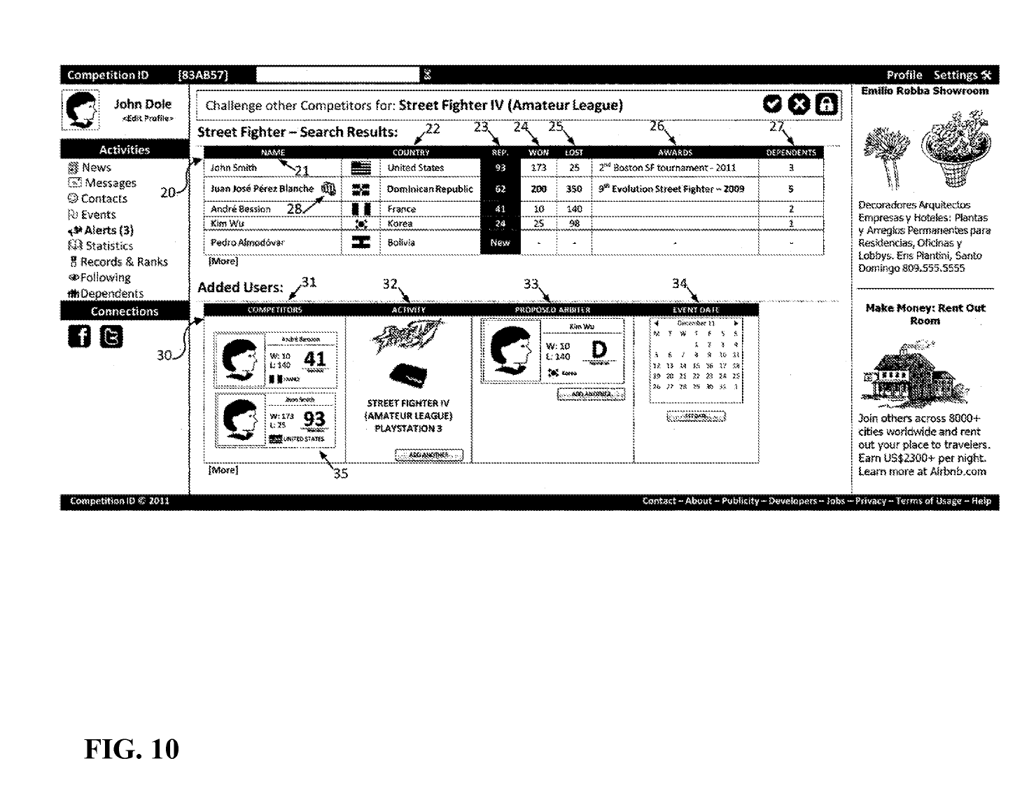

FIG. 10 shows the process of sending challenges request to competitors of an example of a video game event. Users to invite can be found using the search bar 5 then the Users to invite table 20 is populated, the table can contain the following columns:
a) Name 21: Name of the user.
b) Country 22: Name of the country and its flag.
c) Rep. 23: Reputation of the competitor FIG. 14.
d) Won 24: Number of events won.
e) Lost 25: Number or events lost.
f) Awards 26: Awards and ranks received
g) Dependents 27: A link with the number of dependent, profiles.

Users can be added to the Added users table 30 using the Challenge icon 28, the table can contain the following columns:
a) Competitors 31: contains one or more mini profiles FIG. 14 of the users that will be invited to the event.
b) Activity 32: Contains a general description of the activity that will be seen by the invited users, this description is taken from information defined in the Main activity data definition FIG. 5. The user can add another activity to the event, to make a multi activity event by pressing the “Add another” button.
d) Proposed Arbiter 33: contains one or more Mini profiles FIG. 5 of the users that will serve as Arbiters in the event. The user can add another arbiter by pressing the “Add another” button.
e) Event date 34: contains one or more calendar control specifying the date or dates of the event. The user can click on one or more date of the calendar and then press the “Set date” button to save the changes.

Once finished selecting the Competitors FIG. 3:11 and Arbiters FIG. 3:12 the user can press the check mark button on the Activity buttons bar 9, then all requests are sent to the respective users.

FIG. 11 shows pending challenge invitation in a Competitor User profile. Pending challenges are displayed in the Challenges table 20 that can contain the following columns:
a) Challenge 21: a brief description 30 of the activity that can be comprised of a title, a subtitle and one or more logos as defined in the Main activity definition FIG. 5. The user can accept, reject or set it to respond later by pressing either Accept, Reject or Maybe buttons 31.
b) From 22: contains the mini profile 32, FIG. 14 of the user who sends the challenge request or invitation. The user can report the Activity or event as a fraud by pressing the “Report sender” button 33. In case that the invitation is sent by an official organization or company 40, the user may not be able to report the event as a fraud or scam.
c) Arbiter 23: contains the mini profile 34, FIG. 14 of one or more arbiters attending to the event. The user can Accept, Reject or suggest another Arbiter by pressing either “Accept”, “Reject Arbiter” or “Propose another Arbiter” button. When the challenge is sent by an official organization or company the user cannot reject or suggest another Arbiter.
d) Date 24: contains a read only calendar control 36 showing the day or days of the event. The user can suggest or propose another date for the event by pressing the “Propose another date” button 37. When the challenge is sent by an official organization or company the user cannot suggest another date for the event.
e) Competitors 25: contains one or more mini profiles FIG. 14 of all competitors attending to the event. The user can reject or report an attending competitor by pressing the “Reject competitor” button.
   The user can see more of his pending challenges by pressing the “More” link 80.

FIG. 12 shows pending arbiter requests on a user profile. The events are shown in the Arbiter Requests table 20 which can contain the following columns:
a) Challenge 21: containing general information of the activity 31 that can be comprised of a Title and one or more logos as defined in the Main activity definition FIG. 5. The user can Accept, Reject or set it to respond later by pressing either Accept, Reject or Maybe buttons 30.
b) From 22: containing the mini profile 32 of the user who sent the request FIG. 14. The user can report the user and the activity as a fraud by pressing the “Report sender” button 33.
c) Date 23: containing a calendar control 34 showing the day or days of the event. After accepting the request by pressing the “Accept” button, the user can propose other dates by clicking on the calendar and pressing the “Propose another date” button or can unilaterally change the date by clicking days in the calendar control and then pressing the “Change date” button 33.
d) Competitors 24: Containing mini profiles 36, FIG. 14 of all competitors attending to the event. After pressing the Accept button, the user can disqualify, reject or propose competitors by pressing either “Disqualify competitor”, “Reject one competitor” or “Propose competitor” buttons 37. The arbiter can also propose or disqualify competitors by pressing either “Disqualify Competitor” or “Propose Competitor” buttons 43.

FIG. 13 shows an exemplary list of activities and reputation on a user profile. The Type of reputation is shown in the Reputation indicator 21 and is detailed in an Activities reputation table 20. This table can contain the following columns:
a) Activity 21: containing the Title and the logo of the activity as defined by its creator FIG. 5.
b) Reputation 22: containing a Percentage 31 or a alphabetic letter showing the qualification of the competitor on each activity.
c) Points 23: containing points quantities earned by winning or losing events.
d) Events 24: containing a counter showing the number of events that the user was invited to.
e) Won 25: containing a counter showing won events.
f) Lost 26: containing a counter showing lost events.
g) Rejected 27: containing a counter showing events that the user rejected.
h) Disqualified 28: containing a counter showing events that the user was disqualified from.

A summary line 33 containing an average of the reputation 32 of all events and a total of each Points 23, Events 24, Won 25, Lost 26, Rejected 27 and Disqualified 28 columns is shown at the bottom. Also de Formula 33 for reputation calculation is also shown.

FIG. 14 shows various mini profiles which are a quick way to identify the user and his general data. Information on Mini profiles is always up to date and reflects how good or bad a user is performing in the network. Mini profiles are conformed by an outer frame that can be filled with color according with the reputation qualification, in that sense a mini profile can have its background as follows:
a) Green 1, 5: if the user reputation is A or above 80%
b) Orange 2, 6: if the user reputation is B or between 60% to 79%
c) Yellow 3, 7: if the user reputation is C or between 40% to 59%
d) Red 8: if the reputation is D or below 40%
e) White 4: if the user is new to the network and has not participated in any event.

Mini profiles can have other indicators such as: a User picture 20, 27, the Username 21, Win/Lost counter 22, Reputation qualification 23, 28, Country flag 24 and Country Name 25. Information on Mini profiles is always up to date and reflects how good or bad a user is performing on the network.

FIG. 15 shows an exemplary listing of activities along with Rank awards and reputation. Activities are shown in the Activities table 20 that can have the following columns:
a) Activity 21: containing the title and logo of the activity FIG. 5.
b) Reputation 22: containing the reputation calculation.
c) Events 23: containing a counter of the event requests received.
d) Accepted 24: containing a counter of the events attended.
e) Rejected 25: containing a counter of the events rejected.
f) Points 26: containing a counter of points gained for winning or losing events
g: Rank 27: containing the title and logo of the Rank applied. FIG. 8.

A summarizing line 28 is displayed at the bottom containing an average calculation for all reputations of the activities and a total for other columns.

FIG. 16 shows an exemplary arbiter reputation listing on a user profile. Activities are shown in the Activities table 20 that can have the following columns:
a) Activity 21: containing a general description of the activities 30 that can have a title and a logo FIG. 5.
b) Reputation 22: containing an average percentage 31 or an alphabetic letter.
c) Events 23: containing a counter of the arbiter requests received.
d) Accepted 24: containing a counter or the arbiter requests accepted.
e) Rejected 25: containing a counter of the arbiter requests rejected.
f) Dislikes 26: containing a counter of the dislikes he has received.
g) Points 27: containing a counter of points received for attending to events.

A summarizing line 32 is shown at the bottom of the Activities table 20 with an average of the reputation percentage for all the activities and a total for each other column. A link with the Reputation formula 33 is also shown at the bottom.

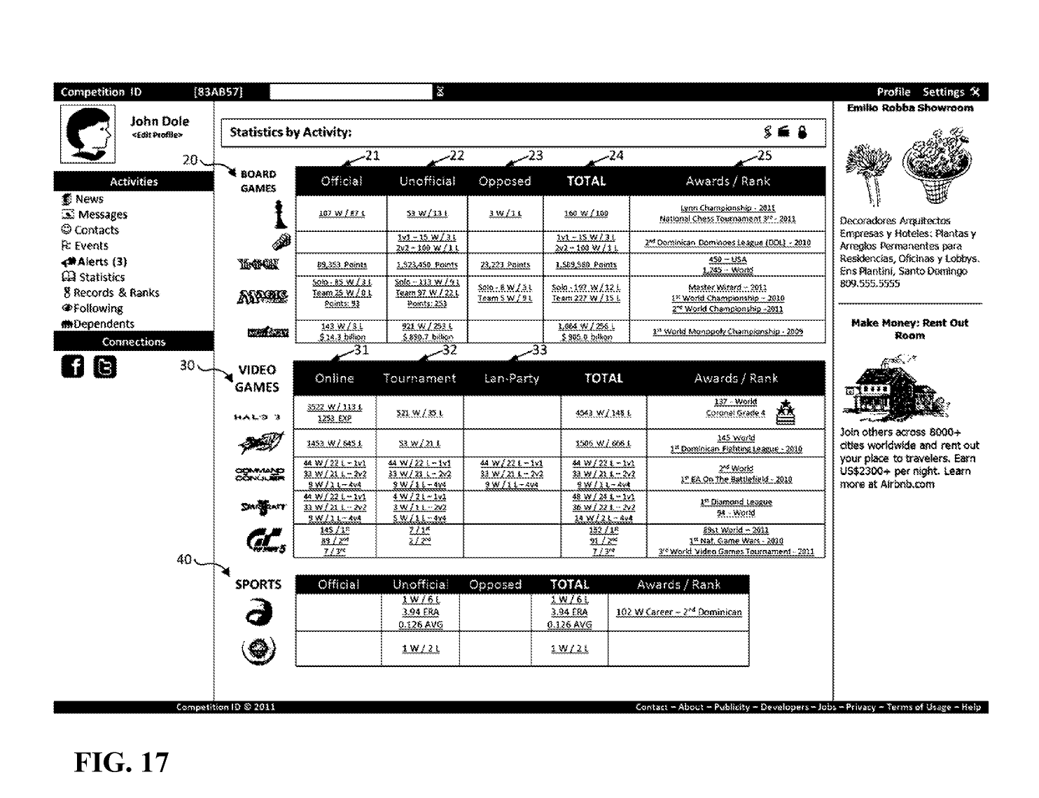

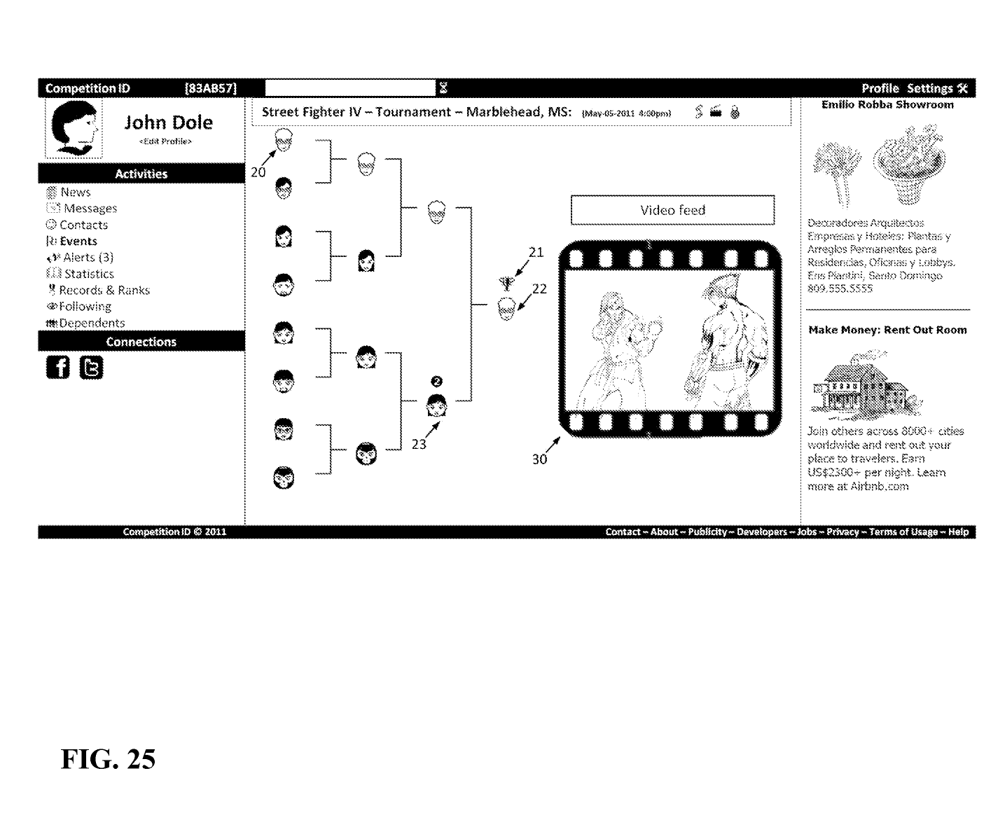

FIG. 17 shows a list of statistics and awards by activity on a user profile. The list of activities is grouped by activities groups such as: Board games 20, Video Games 30 or Sports 40. Each group table 20, 30, 40 can have the following columns:
a) Official 21: containing a counter of won and lost of events managed by an organization.
b) Unofficial 22: containing a counter of won and lost of events not managed by an organization.
c) Opposed 23: containing a counter of won and lost of events that are being verified.
d) Total 24: containing a total of all won and lost counters of previous columns.
f) Awards/Rank 25: containing one or more links of Ranks and Awards.
g) Online 31: containing a counter of won and lost of online events.
h) Tournament 32: containing a counter of won and lost of tournament type events FIG. 25.
i) Lan-Party 33: containing a counter of won and lost of Lan-Party type events.

All grouping definition and classification of those statistics are defined by administrator users FIG. 3:4 to maintain data consistency. All information presented in this screen is generated from the Statistics database Entity FIG. 4:7 and are presented as hyperlinks that can take the user to see more details if pressed.

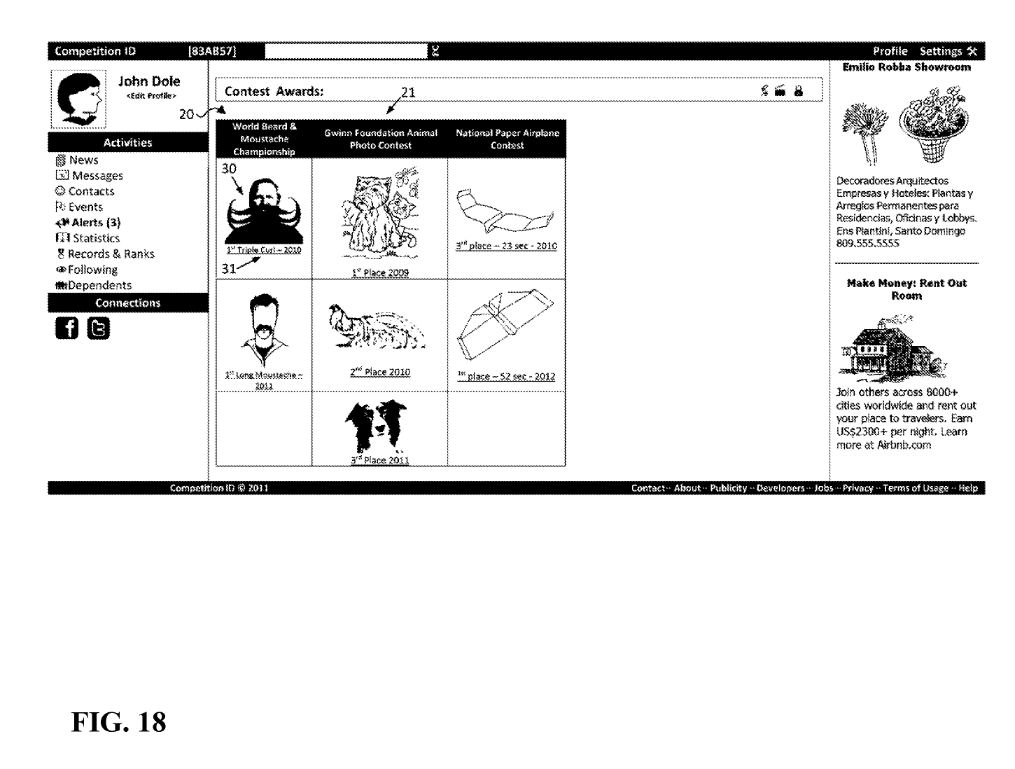

FIG. 18 shows a detailed list of awards received on a user profile. Awards shown in the Awards table 20 can contain a picture 30 and a hyperlink 31 that can take the user to see more details if pressed. If awards are in consecutive years a highlighted title 21 is shown and all related awards are arranged in the same column sorted by year.

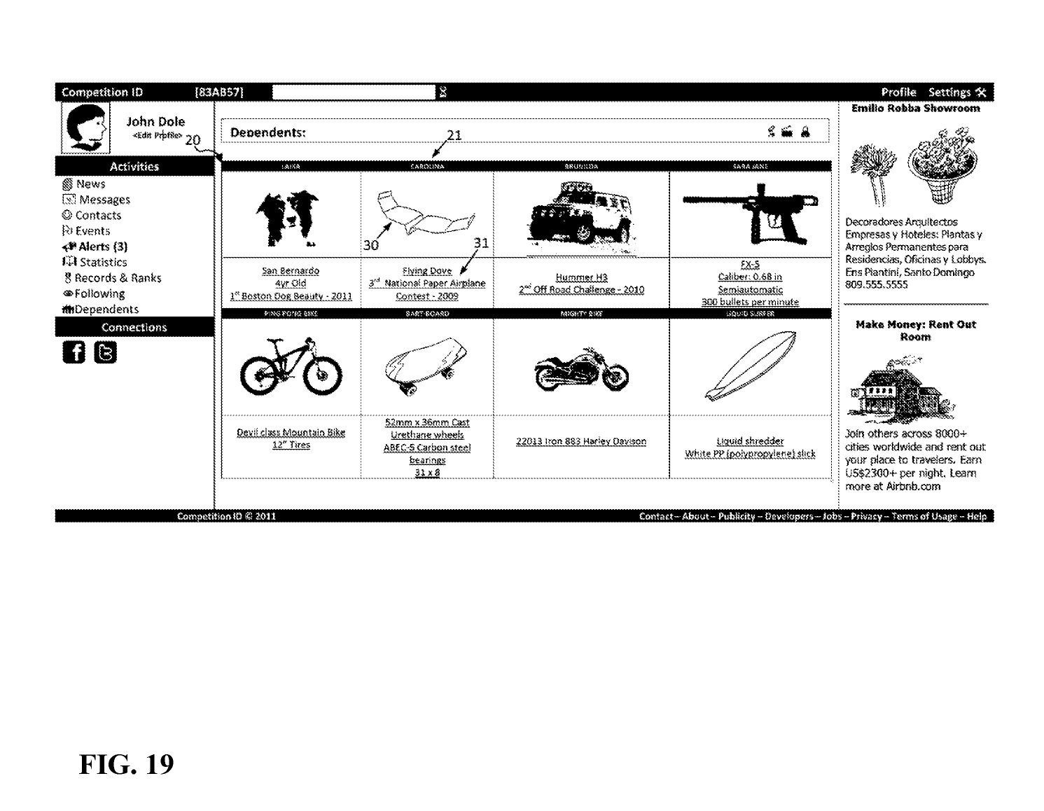

FIG. 19 shows a list of dependent member profiles FIG. 2 on a user profile. The dependent members are listed one for each cell in the Dependents table 20, each cell has the name of the dependent as a highlighted title 21. Each cell can contain a profile picture 30 one or more hyperlinks 31 with awards received by each dependent or a brief description of its main characteristics.

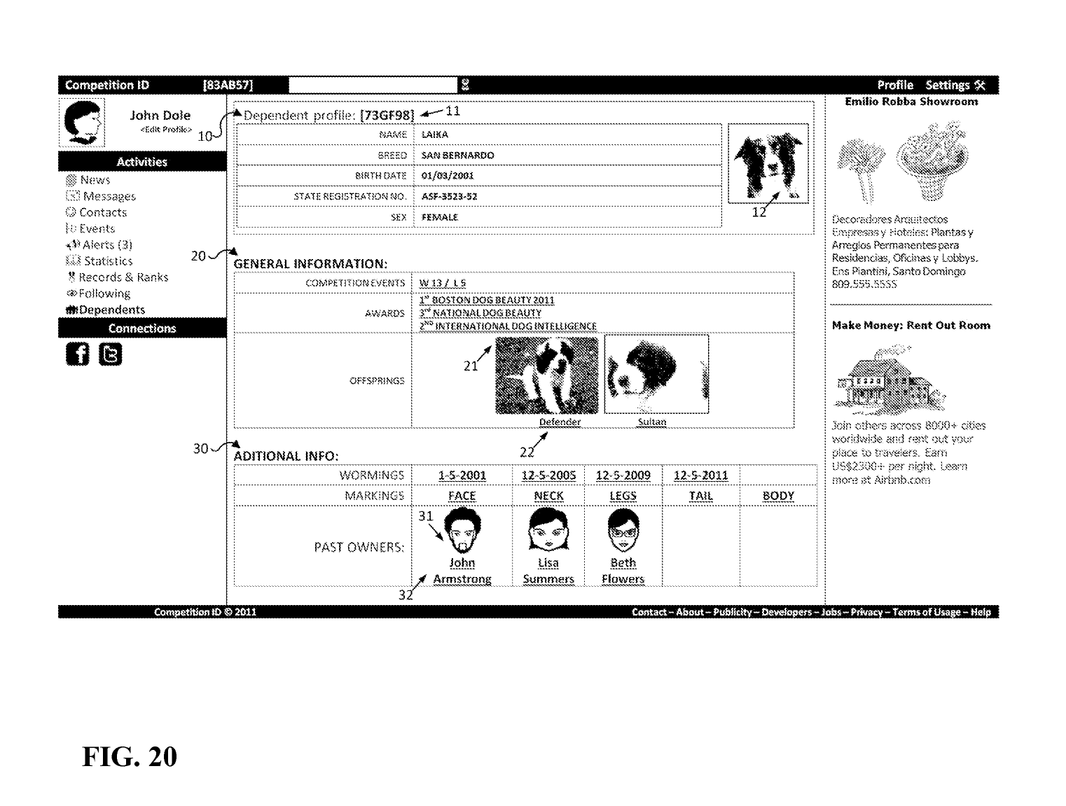

FIG. 20 shows an example of a Dependent member profile FIG. 2 in detail on a user profile. Data is presented to be reviewed or changed in the Profile data 10, General information 20 and Additional info 30 sections. Those sections can have data types according to the Data types defined for each Activity FIG. 6 and additional data that the user can add as complement. The section can also contain links to the awards the dependent member has received. Describing the example of the profile section is as follows:
a) Main profile data 10: comprising of a title cell, a data cell and the profile picture. This section shows the data types defined by the creator of the activity that apply to the dependent member.
b) General information 20: comprising of a title cell and a detail cell. This table is a combination of user added data and generated competition results. The user can also add pictures 21 and links 22 to other dependent member profiles.
c) Additional info 30: comprising of a title cell and one or more detailing cells. This table is a combination of user added data and other data generated by the system. A list of past owners if any is also shown with a picture profile 31 and a link 32 representing the name to show the user more information about past owners of the dependent member in case the dependent member has been sold or lent from other users.

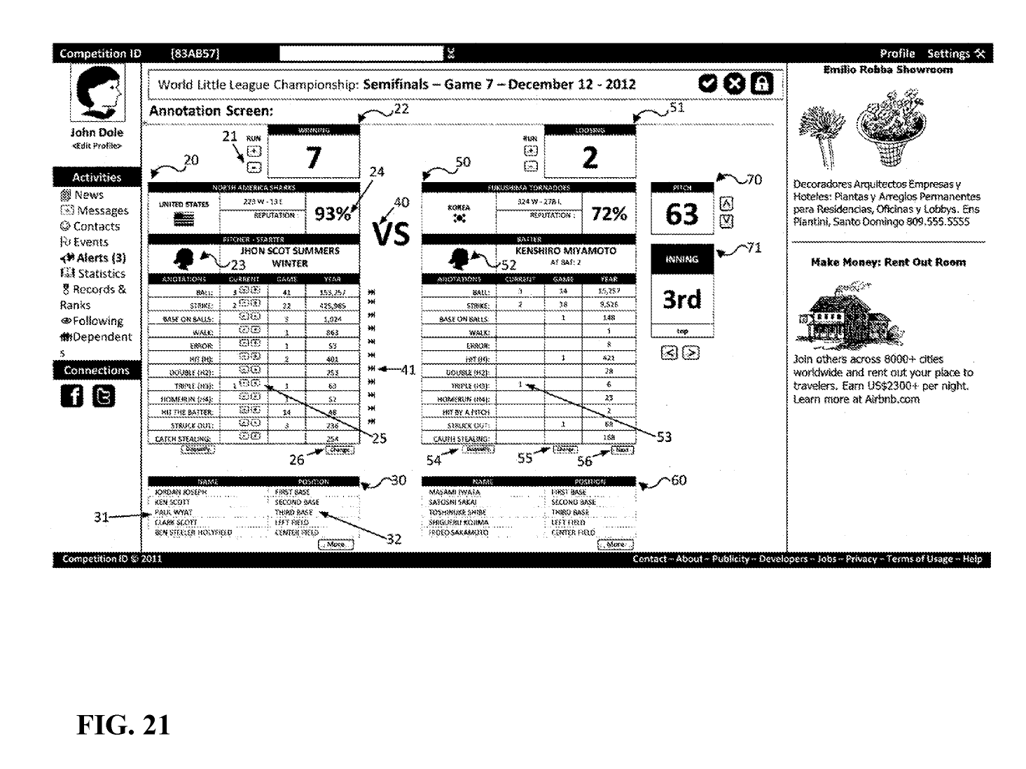

FIG. 21 shows an example baseball annotation section on a user profile. General data about the two competing teams 20, 50 are shown along with the reputation percentage 24. A “VS” indicator shows the connection of the performing pitcher 23 and current batting player 52. Annotation tables are shown below each player description, those annotation players can have the following columns.
a) Annotations: contains the name of the data field.
b) Current: contains a “+” and “−” buttons which the user can press to annotate.
c) Game: contains the statistics of the current game.
d) Year: contains the statistics of the current year.

Connector indicators 41 show the user that the incrementing of any data in one table is connected to the other. e.g.: the incrementing in the “Triple [H3]” 25 data field is marked as allowed by the pitcher 23 and is also marked as “Triple [H3]” 53 batted by the batter 52.

There are other buttons in the annotation screen that the user can use to perform other operations such as:
a) Change 26, 55: used to register a player change
b) Disqualify 54: used to disqualify a player.
c) Next 56: used to change to the next batter in the lineup.

Active roster tables 30, 60 are also shown to let the Annotator user FIG. 3:16 select other players to change or disqualify. The table can have the Name 31 and the Position 32 columns.

Other general annotation cells are shown as follows:
a) Run by team 22, 51: contains the runs for each team the cell also has “+” and “−” annotation buttons and a highlighted title indicating which team is losing or winning.
b) Pitch 70: containing the current pitch as a number and two arrow buttons that the user can use to increment or decrement the number.
c) Inning 71: containing information about the current inning on two cells, and two arrow buttons that the user can use to annotate.

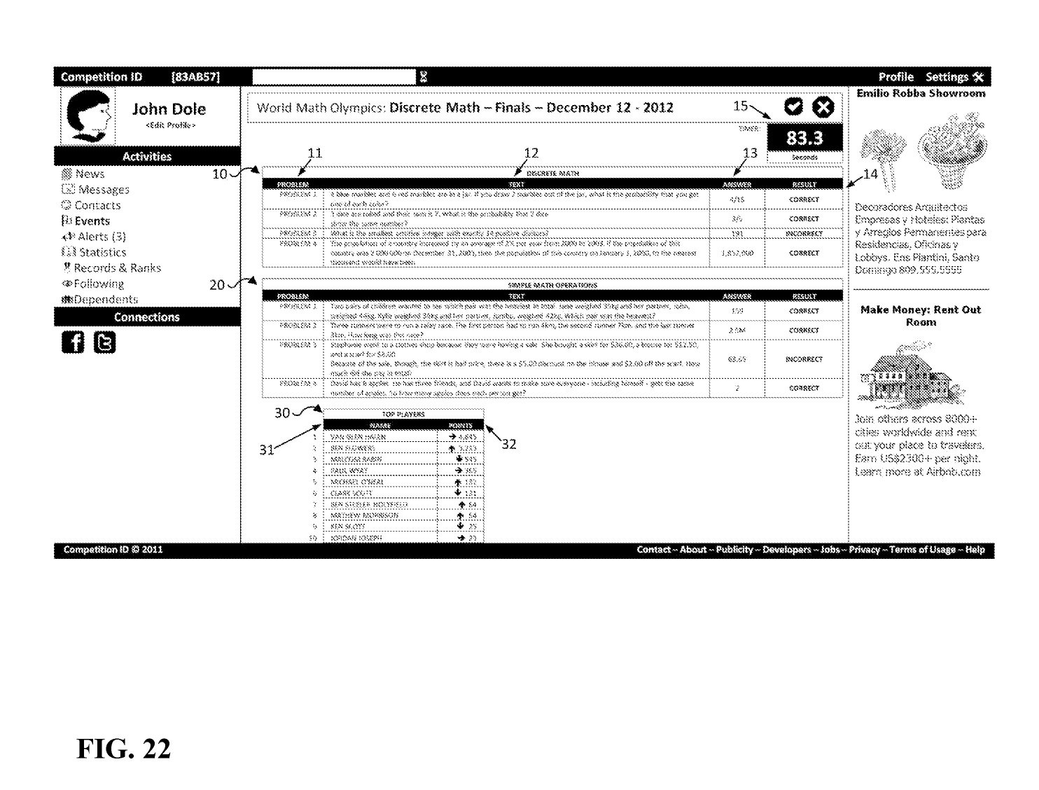

FIG. 22 shows an example discrete math virtual event. In this event while a countdown timer 15 is still counting, users can answer questions in the Discrete math 10 and the Simple math 20 tables. Both tables can have the following columns:
a) Problem 11: containing the title of the problem.
b) Text 12: containing the text of the problem.
c) Answer 13: containing a field where the user can type the answer to the problem.
d) Result 14: containing a text indicator showing the user if the Answer 13 was correct or incorrect.

Also a Top 10 competitor ladder table 30 is shown at the bottom. This table corresponds to a previously defined Top Competitors evaluation method FIG. 3:26, FIG. 4:9 for the Activity. The Top competitor table 10 can have the following columns:
a) Name 31: containing the name of the player or Competitor.
b) Points 32: containing a counter with points gained by each competitor and an arrow indicating if he is ascending, descending or staying in the ladder. Arrows are colored blue if staying, green if ascending and red if descending.

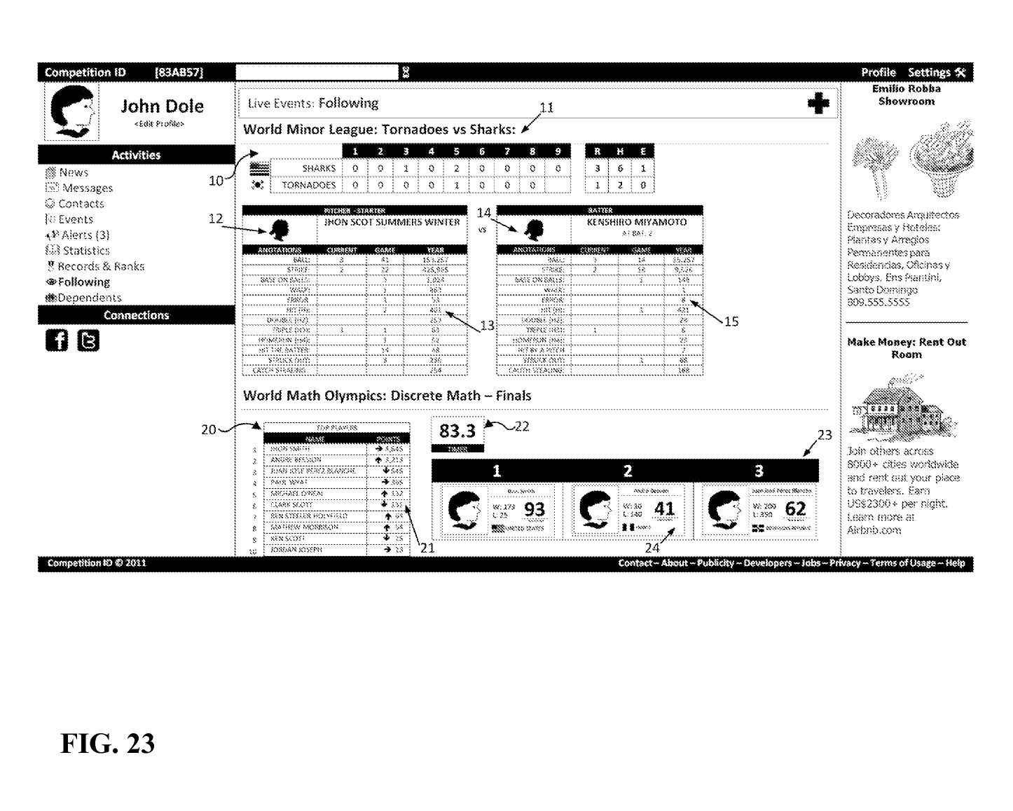

FIG. 23 shows the following of two distinct events on a user profile. In this example a user is following the results of a baseball game 10 and a discrete math tournament 20. Each event has a title 11 and a generated table 10, 20 with columns and cells containing data relevant to the activity. For the baseball game the user can see the runs by inning table 10, also the Pitcher 12 vs. the Batter 14 tables containing information 13, 15 that is updated as they are entered by Annotator users FIG. 21. For the Discrete math event 20 a Top 10 ladder FIG. 3:30, a Countdown timer 22 and a Top 3 competitors table 23 are shown. The top 3 competitors table 23 contains the mini profiles 24 of the top 3 players and is constantly updated during the event.

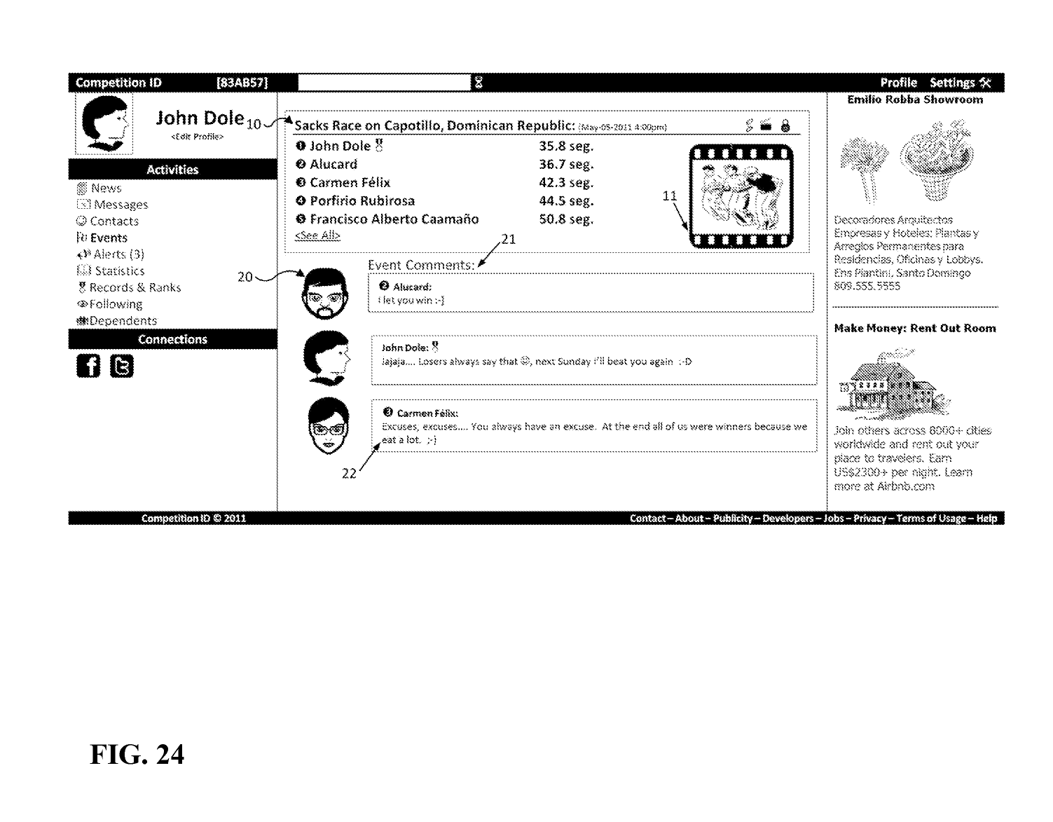

FIG. 24 shows the results of an example of a Single event competition: A sack race. Results of the race are shown in the results table 10 with the names of the top winners along with a highlighted circle indicate their position in the race, and the seconds they made in another column. A video section 11 is also shown where the user can watch the video of the race. A chat section 21 is also shown showing text messages of the users about the race. The sections can contain a User profile picture 20 and the text 22 for each message posted.

FIG. 25 shows an example of a result of a single elimination event: a video game tournament. Here profile pictures of players are shown in a single elimination bracket 20 showing the winner 21 with a cup icon 22 above his profile picture and the player who won 2nd place 23 with a highlighted circle with the number 2 above the profile picture. A video section 30 is also shown where the user can watch videos of the tournament if any.

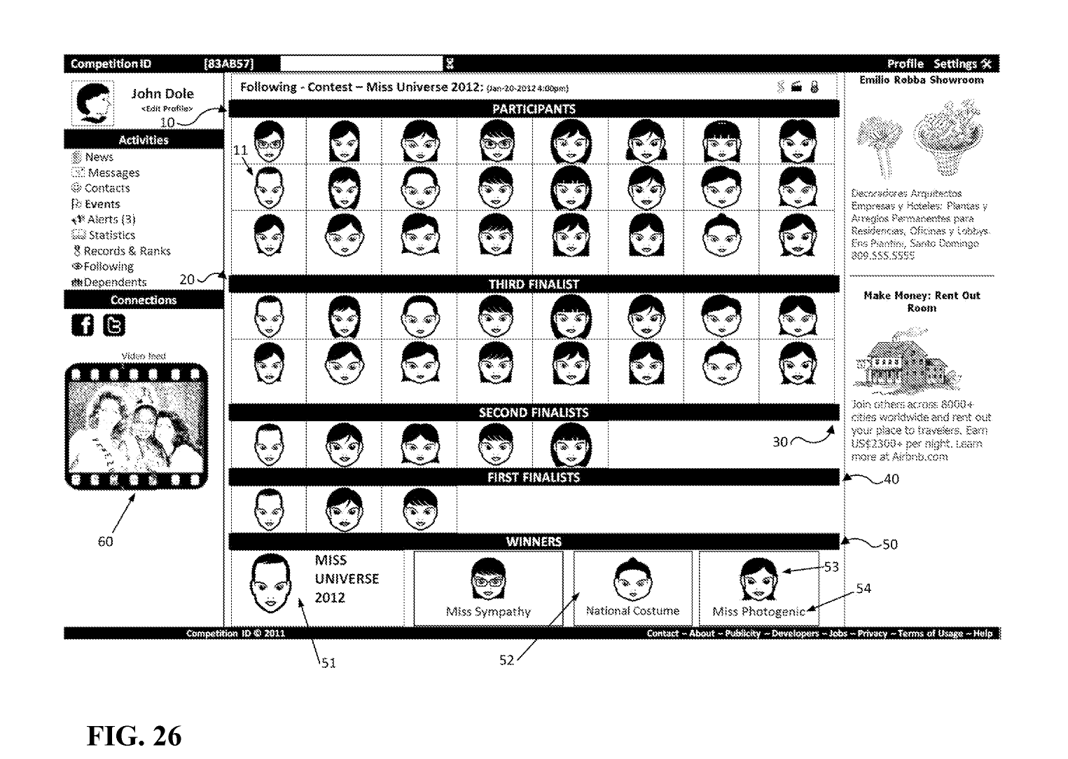

FIG. 26 shows the results of an example of a contest event: A beauty contest. Here a Picture profile for each competitor is shown in the Participants 10, Third finalist 20, Second finalist 30, First finalist 40 and Winners 50 tables. Winners table have in a single colored cell 51 the profile and picture of the winner shown at a bigger size that the competitors who won honor awards 52, those winners have both Picture profile and Honor award title 54 at a smaller size. A video section 60 is also shown where the user can watch videos of the contest if any.

FIG. 27 shows re results of a round robin tournament of an example of a Little league baseball activity. The results are divided into two tables for the Group A 10, and the Group B 20 categories. The two tables show a Title 11 with the name of the group and the age range, a first column with team names 12, a first line with team names and a Total column 13, 21 with a total of all games won by each team. Other cell contains a 1 if the team won the game or a 0 if the team lost the event. A blocked dark cell for each cross section of the same team is also shown on each table.

FIG. 28 shows an example of a global search on the network. Clickable categories 11 are shown in the Categories Column 10 to facilitate the user to find what he is looking for more easily. Results tables 20, 30, 40 can have the following columns:
a) Name 21: containing the name of the competitor or the name combined with a picture of a Tool 41, Vehicle 42 or Team 43.
b) Country flag 22: containing a small flag picture.
c) Country 23: containing country names.
d) Rep. 24: containing the reputation qualification as a percentage number or an alphanumeric letter.
e) Won 25: containing a counter of events won.
f) Lost 26: containing a counter of events lost.
g) Awards 27: containing links of awards and ranks
h) Dependents 28: containing a counter of dependent member profiles.
i) Owner 44: containing the name of the owner of the dependent member.
j) ORG. 31: containing a small logo 32 of the organization the competitor belongs.

Users can see more search results by pressing the “[More]” hyperlink 33. Also the user can click on any category of the Categories column 10 to filter the resulting tables 20, 30, 40. More precision searches can be made by using the generated filters of the Filters column 11 such as: Gender 13 or City 14.

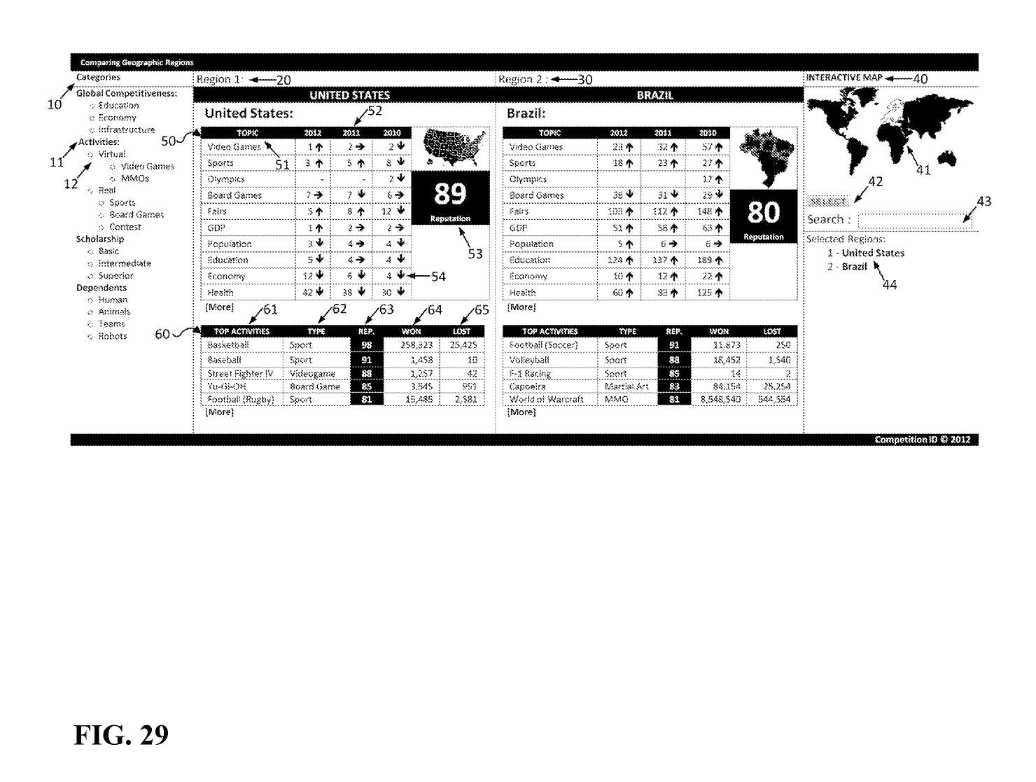

FIG. 29 shows an exemplary comparison between two geographic regions: USA vs. Brazil. To select the regions he wants to compare the user can click in the interactive map 40 region showing a zoom capable map which the user can use to identify the region he wants to compare. After the user clicks and selects the region he can use the “Select” button to add the geographic region to the Selected Regions list 44. The user also has the option to search a specific region by typing directly in the Search field 43.

Once selected, the system generated categories are shown in the Categories column 10 with Activities 11 and sub activities 12 the user can then click on any of those to filter the comparison. For each geographic region a Master comparison table 50 is shown, those tables have a Topic column 51 with the name of the activity and one or more Sub columns 52, one for year of data. Cells on Sub columns 52 show the standing of the geographic region with a number and a colored arrow 54. This arrow can be colored green if the region is going up in the standings from previous years, Red if is going down or Blue if have no change in the standings from previous years. Data sources for the Master comparison 50 of geographic regions can be taken from the network or other official sources.

A top activities table 60 is also shown for each geographic region. Those tables can have the following columns:
a) Top Activities 61: containing the name of the Activity FIG. 3:20.
b) Type 62: containing a classification of the Activity FIG. 3:20.
c) REP. 63: containing the reputation qualification represented by a percentage number or an alphabetic letter.
d) Won 64: containing a counter of events won.
d) Lost 65: containing a counter of events lost.

Once the reputation is calculated from all the activities a reputation qualification is shown on each Country cell 53, those cells contains a mini map of the region and a reputation qualification at the bottom represented by an alphanumeric letter or percentage number.

FIG. 30 shows three examples of comparisons that the users can do in the network: a) military aircraft 20, b) celebrities 30 and c) vehicles 40. The comparison engine can search and collect data from other sources and can highlight the topic on which an element is better than the other based on predefined rules for each data. e.g.: for Speed of a vehicle the higher number is better.

Therefore for the first table 20 comparing the F-22 22 Raptor vs. the PAK-FA 23, the comparison engine can highlight as green any of the specifications obtained from official websites. The comparison columns can also contain charts 24 or diagrams and the User votes 25 such as: Likes, dislikes, neutral and the total of votes.

For the second table 30 comparing celebrities, the comparison engine can look for data from web sources like Forbes and can combine them with user votes to determine the reputation qualification 33, 34.

The third table 40 comparing vehicles, the engine can look for official websites to retrieve data for various models 41, 42 and combine them with user votes to determine the reputation qualification.

While the present invention has been described in connection with the preferred embodiments of the various Figs., it is to be understood that other similar embodiments may be used or modifications and additions may be made to the described embodiment for performing the same function of the present invention without deviating therefrom.

What is claim is:

1. A computer-implemented method, comprising:
Creating activities with one or more custom sets of data types, rules, formulas and ranking system definitions to mimic a virtual or live activity; or creating activities by using or modifying an existing set of rules, data types, formulas and ranking systems definitions as a template;
Adding and maintaining data of all means they use to compete;
Participating in competition events, having all data generated in said events on a centralized profile;
Sending requests and invitations to events where a predefined set of rules will apply;
Challenging one or more users, inviting them to an event that will be certified by an arbiter;
Establishing competition based relationships;
Accepting one or more arbiter designations to judge one or more events;
Sharing data and statistics;
Following users, organizations, dependent profiles, events or competition activities; and
Comparing network elements based on competition data and other sources;

2. The method cited in claim 1, further comprising a Human, Organization or Artificial intelligence that can login as a user into the network to perform one or more operations using one or more user roles.

3. User roles cited in claim 2, further comprising a set of privileges that can be automatically assigned by the system based on what the user does, or can be manually assigned by administrative personnel from the company that runs the network.

4. User roles cited in claim 2 further comprising the process of manually or automatically assigning a set of privileges based on operation that each user does in the network comprising:
Commissioner: when creating an activity;
Sponsor: when creating an activity and transferring control to another user;
Competitor: when joining an activity and participating in one or more events;
Follower: when subscribing to one or more elements of the network to receive continuous updated information on those topics;
Arbiter: when accepting a request to judge an event;
Annotator: when accepting a request to enter or capture data of an event;
Scout: when subscribing to the network as an talent seeker; and
Administrator: manually assigned to personnel of the company that runs the network.

5. Follower user role cited in claim 4, further comprising the right to do one or more operations comprising:
Following one or more users, activities, organizations or dependent members;
Following one or more Events of a specific activity;
Joining activities to view statistics, rakings and top competitors;
Comparing two or more elements of the network using the Comparison System cited in claim 50; and
Voting on polls or surveys.

6. Competitor user role cited in claim 4, further comprising the right to do one or more operations comprising:
Viewing statistics, rankings and top competitors of a given activity before joining;
Joining a competition activity, team, organization or event;
Participating in one or more events of any activity he joined;
Viewing his statistics and reputation of activities he has participated in;
Viewing and sharing his position on Top Competitors listings on an activity he joined;
Sending requests to Commissioner users, asking them to impugn, review or disqualify events, competitors, data or arbiters; and
Accepting or denying request sent by other users such as: team, challenge or follow.

7. Arbiter user role cited in claim 4, further comprising accepting an arbiter request which give the user the right to do one or more operations on one or more events comprising:
Sending request to join a competition activity;
Accepting arbiter invitations to judge competition events;
Approving, certifying or disqualifying data, competitors or rules of an event once accepted as an arbiter;
Disqualifying competitors and specific data before or after the event took place;
Canceling or rescheduling competition events;
Viewing statistics on activities he has participated in;
Viewing top competitors in an activity he has participated in; and
Viewing the complete profiles of Competitor users attending to a competition event.

8. Annotator user role cited in claim 4, further comprising the right to do one or more operations comprising:
Entering or Capturing competition data on an event; and
Correcting a mistake he made on the data before the data is certified by a user with the Arbiter user role.

9. Commissioner user role cited in claim 4, further comprising the right to do one or more operations comprising:
Creating or changing competition activities with all related data such as data types, rules, formulas or ranking systems;
Accepting or denying one or more request to be Commissioner of an activity sent by other users;
Changing existing competition data types, rules and formulas;
Scheduling, rescheduling or canceling an event;
Approving subscriptions requests to his activity sent by other users;
Approving, certifying or impugning an event;
Disqualifying competitors or Arbiters attending to an event and all data related;
Interacting with statistics definitions or creating new ones to view all the data related to an activity he created or has been assigned to be the commissioner of;
Defining or changing the ranking system of an activity;
Defining or changing the top competitor criteria of an activity he created or has been assigned as a Commissioner;
Sending invitations to one or more competitors to one or more events of the activity he created or has been assigned to be the Commissioner of; and
Responding to dispute requests made by users related to the activity he created or has been assigned to be the Commissioner of.

10. Sponsor user role cited in claim 4, further comprising the right to do one or more operations comprising:
Creating or changing competition activities and assigning another user to be the Commissioner;
Viewing top competitors, ranks and statistics of an activity he is sponsoring;
Interacting with previously defined formulas of an activity he is sponsoring or creating new ones to calculate and view competition data the way he wants;
Convening, Scheduling, Rescheduling or Canceling competition events on an activity he is sponsoring.
Viewing all events on a competition activity he is sponsoring; and
Sending invitation request to competitor users asking them to participate in one or more competition events he is sponsoring.

11. Scout user role cited in claim 4, further comprising the right to do one or more operations comprising:
Sending scout requests to Commissioners of competition activities to be able to follow and see all data related to a specific activity;
Creating formulas and reports to see competition data the way he wants; and
Sending special requests and offers to talented users in the activities he was allowed to scout.

12. Administrator user role cited in claim 4, further comprising the right to do one or more operations comprising:
Maintaining all network information infrastructure elements such as servers, routers, cabling or databases;
Resolving problems and correcting mistakes the data; and
Taking disciplinary actions against any element on the network that violates company policies.

13. Creating activities cited in claim 1, further comprising adding and arranging in a logical way a set of custom data types, formulas and predefined rules by users with the Commissioner or Sponsor user roles.

14. Arranging a set of data and formulas in a logical way as cited in claim 13, further comprising manipulating a set of software predefined data types and the default rule that will apply to each one. Each data type can refer to previously created data elements or can represent itself as a standalone element.

15. Default rule cited in claim 14, further comprising specifying predefined operators to enforce data validation comprising:
Numbers: designed to store positive or negative numeric data;
Competitor Type: designed to store the specification of a competitor type such as: human, organization, robot or dependent member;
Event type: designed to store the event type definition such as: single event, round robin, single elimination, double elimination or contest;
Time: designed to store numeric values related to time; and
Letters: designed to store alphanumeric characters.

16. Custom data types as cited in claim 13, further comprising adding data elements that can store data element with special meaning in the network.

17. Data elements with special meaning as cited in claim 16, further comprising one or more rules that govern the type of data that can be stored, comprising:
Competitor type: containing the type of competitor such as: Human, Organization, Animal, Vehicle, Robot or Tool;
Event Type: containing the type of event such as: Single event, Single Elimination Tournament, Double Elimination Tournament, Round Robin, Contest;
Event Group: containing one or more event parts, from a bigger event, such as: game, contest or Tournament;
Event Part: containing one or more element of an event group, such as: Round, Match, Inning, Quarter time, or Half time;
Event Duration: containing a numeric value that defines the duration of an event or one of its parts;
Arbiter Rule: containing a specification that one or more Arbiters must check and approve; and
Counter: containing a numeric value designated to count one or more elements in a competition event.

18. Predefined rules as cited in claim 13, further comprising one or more software validation checks to ensure that data is entered correctly.

19. Software validation checks cited in claim 18, further comprising:
More than: indicating that more than the default number or quantity can be allowed;
Less than: indicating that no more than the default number or quantity can be allowed;
Arbiter check: specifying a data that the attending arbiter must manually check and approve;
Single elimination: indicating that a competitor is out of the event if loses once;
Double elimination: indicating that a competitor is out of the event if lose twice;
Best of: indicating an evaluation of a group of events specified by a numeric value; the competitor with most wins of said group of events is the winner;
Win: specifying a condition that determines the winner of an event. This condition can be numeric, alphanumeric, an arbiter check or a combination of one or more of the previously mentioned conditions; and
Lose: specifying a condition that determines the loss of an event. This condition can be numeric, alphanumeric, an arbiter check or a combination of one or more of the previously mentioned conditions.

20. Adding all means user use to compete as cited in claim 1, further comprising adding and maintaining data of one or more secondary profiles containing the data of any mean a competitor uses to compete alongside with him or in his name; those dependent member profiles can accommodate any real or virtual element such as animals, plants, vehicles, tools, gadgets or teams.

21. Adding and maintaining data of one or more secondary profiles cited in claim 20 further comprising the action of passing said secondary profiles from one user to another. When this happens the secondary profiles retain all previous competition data, achievements, custom data and statistics. Also a record of previous primary users or owners is kept for history purposes.

22. Animals as cited in claim 20, wherein referring to any living being except humans that can move from one place to another by its own means.

23. Plants as cited in claim 20, wherein referring to any vegetative living being that cannot move by itself.

24. Vehicle as cited in claim 20, wherein referring to a mobile mechanism that is used to transport passengers or cargo that include mechanism that can travel on land, water, air or outer space.

25. Tools as cited in claim 20, wherein referring to any physical item that can be used to achieve a goal and it's not consumed in the process.

26. Gadgets as cited in claim 20, wherein referring to a tool or machine that has a particular function, but is often thought of as a novelty.

27. Teams as cited in claim 20, wherein referring to a group of Humans, Animals, or artificial intelligences linked in a common purpose.

28. Participating in competition events as cited in claim 1, further comprising one or more users with the Arbiter, Competitor or Annotator roles to join one or more events and add data by interacting with the rules and formulas previously defined for that event or letting other users with the Arbiter or Annotator user roles enter the data related to his participation in the event if the participates in the event as a Competitor.

29. Participating in competition events as cited in claim 1, further comprising users being evaluated automatically by the Reputation system after the event closes.

30. The Reputation system as cited in claim 29, further comprising a service that qualifies users based on their competition data, the result of those calculations are expressed by a percentage number or an Alphanumeric Character such as a letter.

31. Sending requests and invitation to events as cited in claim 1, further comprising sending a special message from a user with the Commissioner or Sponsor role to one or more users asking them to participate in one or more events.

32. The special message asking to participate in one or more event as cited in claim 31, wherein the receiving user can answer in several ways, including:
Accept: The user is listed on the attenders to the event or activity;
Reject: The request is dismissed and the user is no longer related to the event or activity in any form; and
Report sender: report the request as a spam to an administrator user.

33. The Accept action as cited in claim 32, further comprising the privilege of viewing all relevant data about the activity and the specific event. Once accepting the invitation the user can also view the users that will compete against him or her in the event.

34. The Accept action as cited in claim 32, further comprising other operations that users can do before the event take place such as:
Accept arbiter: The user accepts being judged by the arbiter;
Reject arbiter: The user do not accept being judged by the arbiter, in which case an rejection request is sent to the Commissioner of the activity;
Propose another arbiter: The user specifies another user to be included as an arbiter for the event;
Propose another date: The user proposes another day for the event or activity to take place; and
Reject competitor: The user rejects a competitor, sending a check request to either the Arbiter or the Commissioner of the activity.

35. Challenging other competitors as cited in claim 1, further comprising sending a special message from one Competitor user one or more Competitor users asking them to compete against him in an event that will be judged by a proposed arbiter.

36. The special message asking to compete as cited in claim 35, wherein the receiving user can answer in several ways, including:
Accept: The user is listed on the attenders to the event or activity;
Reject: The request is dismissed and the user is no longer related to the event or activity in any form; and
Report sender: report the request as a spam to an administrator user.

37. Establishing competition driven relationships as cited in claim 1, wherein are established automatically when users do operations on the network or by request from one user to another. Users can have one or more relationships. Competition based relationships comprise but are not limited to: Teammate, Roommate, Mentor, Colleague, Rival, Opponent or Enemy.

38. The Teammate relationship as cited in claim 37, further comprising automatically assigning a relationship that joins all members of the same team. The relationship is automatically assigned when a user joins a team and lost when the user leaves the team.

39. The Roommate relationship as cited in claim 37, further comprising automatically assigning a relationship that joins all members of the network who check into a place. The relationship is automatically assigned when the member check into the place and lost when leaving the place.

40. The Mentor relationship as cited in claim 37, further comprising automatically assigning a relationship that joins a user with a team or organization. The relationship is automatically assigned when the user accepts to be the mentor of the team becoming the mentor of all members of the team and the team itself and lost when the user leaves the team organization.

41. The Mentor relationship as cited in claim 37, also further comprising automatically assigning a relationship that joins a user who ask for help to another user. The relationship is automatically assign while the helping user is helping the helped user and lost when the helping period ends.

42. The Colleague relationship as cited in claim 37, further comprising automatically assigning a relationship that joins all Mentors of the same team or organization. The relationship is automatically assigned when a Mentor is assigned to a team or organization and lost when the Mentor leaves the team or organization.

43. The Rival relationship as cited in claim 37, further comprising automatically assigning a relationship that joins two or more competitors that competes against each other on a regular basis. The relation is automatically lost when the competition ratio between those competitors decreases in time.

44. The Opponent relationship as cited in claim 37, further comprising automatically assigning a relationship that joins two or more competitors who compete in an event. The relation is automatically lost when the event ends.

45. The Enemy relationship as cited in claim 37, further comprising automatically assigning a relationship that joins two or more Robot or artificial intelligences competitors who compete against each other in events which involve the physical or virtual elimination of at least one of them. This relationship is automatically assigned only when the competitors join a virtual competition event, War simulation or videogame session and is lost when the virtual event, War simulation or Videogame session ends. This relationship cannot be assigned to living beings.

46. Be elected as an arbiter as cited in claim 1, further comprising accepting one or more requests to judge one or more events. Any user can be elected as an arbiter by the user who creates the event or send a challenge request cited in claim 35. After accepting an arbiter request the accepting user can then view all profiles and statistics of competitors attending to the event and can perform other operations in the event comprising:
Disqualify: Action of Disqualifying a competitor or dependent, voiding all data gained;
Reschedule: Set the event to take place in another moment, day, month or year; and
Approve: Accept and certify data previously entered by him or other users.

47. Share action as cited in claim 1, further comprising sending information to other networks to be viewed and commented by users of said networks, those networks comprise but are not limited to social networks, business networks or student networks. Information that can be shared to other networks comprises but is not limited to Ranks, Achievements, Events results, Dependent member data or Announcements.

48. The follow action as cited in claim 1, wherein a user adds one or more elements of the network to receive updated information about them. Those elements of the network comprise but are not limited to: Users, Organizations, Teams, Dependent members, Events or Activities. The user can also choose the time period that this information is updated and sanded to be viewed in his profile. Said time periods comprises but are not limited to seconds, minutes, hours, days, weeks or years.

49. The compare action as cited in claim 1, further comprising adding two or more elements of the network to a virtual computational space to view automatically computed comparisons of each one versus the others.

50. Automatically computed comparisons cited in claim 49, further comprising calculating which element is better than the other based on data collected on the network and other external sources. Said calculations take place when computing both the data element and the Which is better rule.

51. The Which is better rule cited in claim 50, further comprising analyzing a special declaration attached to each data element that instructs the computation system to choose as winner one or more comparing elements. Said special declarations comprising:
More: a higher numerical value is better;
Less: a lower numerical value is better;
Before: an earlier time value is better;
After: a later time value is better; and
Value: a specific numeric or alphanumeric value is better.

52. A distributed computer system that provides a service to users using one or more connected devices over a network to perform a method comprising:
Receiving and storing information about competition or recreational activities;
Generating consolidated user profiles for each user, having all data the user generates or follows in said central virtual space;
Generating mini profiles showing basic user information and his reputation;
Providing a search infrastructure based on competition data;
Providing a user interface for the comparison of two or more elements of the network based on competition data and other sources as cited in claim 49;
Providing a user interface for the creation and administration of one or more activities, as cited in claims 13 to 19;
Providing a user interface for adding dependent member profiles of one or more non-user element used to compete in events, as cited in claims 20 to 27;
Providing a user interface for users to send and receive one or more invitation requests, as cited in claims 31 to 34;
Providing an interface allowing users to chat and add comments to events;
Providing an interface allowing users to send or share their data and achievements to other networks, as cited in claim 47;
Provide a user interface to receive the information of other elements of the network a user is following, as cited in claim 48;
Providing a user interface to manage one or more challenge requests as cited in claims 26 and 27; and
Providing a user interface to manage one or more Arbiter request as cited in claim 46.

53. The distributed computer system cited in claim 52, further comprising one or more server farms, a connection mean such as the internet and network connected devices.

54. Server farms as cited in claim 53, further comprising one or more physical locations in which one or more servers can be installed and connected. Those servers comprise but are not limited to: Web servers, Database servers, Application servers, Mobile app servers, Firewall servers or Load balancing servers.

55. Servers as cited in claim 54, further comprising a computer machine with a processor, a memory, an being programmed, via executable program instructions to run one or more services that can store or retrieve data from storage means, process data at a user request and send the results to the user using a network connection.

56. The Web servers as cited in claim 54, further comprising specialized software to perform operations and send or receive information using web standard ports and protocols.

57. The Database servers as cited in claim 54, further comprising specialized software for storing and retrieving information from one or more Databases stored into one or more memory devices such as Hard disks, Random Access Memory Modules or Solid State Drives.

58. The Databases cited in claim 57, further comprising one or more SQL and No-SQL databases. SQL databases are used to store and retrieve structured and slow changing data and rules while No-SQL databases are used to store and retrieve semi-structured fast changing data and rules.

59. The Application servers as cited in claim 54, further comprising specialized software to retrieve data from database servers, make calculations and send said information to requesting applications running on personal computers and videogame consoles.

60. The Mobile application servers as cited in claim 54, further comprising specialized software to retrieve data from database servers, make calculations and send said information to requesting applications running on mobile devices.

61. The Firewall servers as cited in claim 54, further comprising specialized software to filter unauthorized access to the server farm from user not belonging to the network or filtering access to users not accessing the services using the correct ports.

62. The Load balancing Servers as cited in claim 54, further comprising specialized software to redirect flow of data, ensuring that all servers doing the same function have the same processing or network workload.

63. The Internet connected devices as cited in claim 54, further comprising devices that can connect to the server farm using a network to perform operations or send and receive information, said devices comprising: Personal computers, Tablet devices, Laptops, Smartphones, Home videogame consoles, Portable videogame consoles, Robots or Smart televisions.

64. The Personal computers as cited in claim 63, further comprising computing devices comprising of a processor and a memory whose it size makes it useful for individuals to be operated on a desk or table.

65. The Laptops as cited in claim 63, further comprising computing devices comprising of a processor, a screen and a memory whose it size make it useful for individuals to be carried and operated in many environments.

66. The Tablet devices as cited in claim 63, further comprising one piece computer devices with a processor and a memory primarily operated by a touch screen whose it size makes it useful for users to operate them in any environment.

67. The Smartphones as cited in claim 63, further comprising mobile devices with advanced computing capabilities whose wide range of functions make them useful for users to use them as a substitute for several other electronic devices such as mobile phones, mp3 players, digital agendas, calculators, personal digital assistants, digital cameras, video cameras, PC web browsers or GPS navigators.

68. The Home videogame consoles as cited in claim 63, further comprising an interactive computers or customized computer systems which can be used with a display device such a TV or Monitor to display a game.

69. The Portable videogame consoles as cited in claim 63, further comprising lightweight portable electronic devices with a built-in screen, game controls, speakers and a battery whose main purpose is to display a game.

70. The Robots as cited in claim 63, further comprising mechanical apparatus comprised of electromechanical parts guided by a computer program or electronic circuitry.

71. The Smart televisions as cited in claim 63, further comprising network connected hybrid televisions whose it primarily design is to display on demand video, run internet connected apps or surf the web.

72. Receiving and storing information as cited in claim 52, further comprising specialized software which can reside on one or more servers to perform operations comprising:
providing a user interface to users for the definition of one or more activities as cited in claims 13 to 19;
providing a user interface to users for adding dependent profiles as cited in claims 20 to 27. providing a user interface to users for participating in one or more competition events as cited in claims 29 to 30;
providing a user interface to users for sending one or more invitations to one or more events as cited in claims 33 to 35;
providing a user interface to users for sending one or more challenge requests as cited in claim 36;
providing a service for automatically assigning competition driven relationship as cited in claims 38 to 46;
providing a user interface for users to manage arbiter request as cited in claim 47;
providing a user interface for users to share information as cited in claim 48; and
providing an interface for users to follow other elements of the network as cited in claim 49.

73. Generating a consolidated user profile as cited in claim 52, further comprising a centralized virtual space in which users can perform operations and have all data related to competition activities, dependent members or updates about elements of the network the user is following.

74. The centralized virtual space cited in claim 73, further comprising the result of one or more dynamic calculations from various database sources and text or picture hyperlinks that enables the user to perform one or more operation when pressed.

75. Database sources as cited in claim 74, further comprising database entities to store data and rules. Those database entities comprise but are not limited to: Activity, Competition data, Formula, Event, Statistics, Rank or Top Competitors.

76. The Activity database entity as cited in claim 75, wherein basic activity definition and rules are stored such as: title, subtitle, logo, class, type or supporting company logo.

77. The Competition data database entity as cited in claim 75, wherein custom data types, link to other data types and default rules are created are stored.

78. The Formula database entity as cited in claim 75, wherein arithmetic operators and calculation steps are declared and linked to previously declared custom data types.

79. The Event database entity as cited in claim 75, further comprising an instance of the custom data types are created and filled by the users one for each occurrence of the activity previously created.

80. The Statistics database entity as cited in claim 75, wherein contains one or more results of one or more calculations using formulas created in the Formula database entity and applying them to the data instances stored in the events database entity.

81. The Rank database entity as cited in claim 75, wherein containing one or more rules or goals that competitors must meet to be rewarded.

82. The Top Competitors database entity as cited in claim 75, wherein containing one or more rules to select and reward the best competitors of the activity and the period of time this reward will remain.

83. Generating mini profiles as cited in claim 52, further comprising automatically generating a portion of the screen containing basic user data and a calculated result showing his reputation in all his activities to date.

84. Basic user data as cited in claim 83, comprising but not limited to profile picture, name, last name, country name, country flag, events won, events lost, total of events, new indicator, reputation percentage, reputation letter.

85. The portion of the screen as cited in claim 83, further comprising a background frame that is filled with color according to the reputation result. Background colors according to reputation result comprise but is not limited to:
Red: for a percentage from 0 to 39 or letter D;
Yellow: for a percentage from 40 to 59 or letter C;
Orange: for a percentage from 60 to 89 or letter B; and
Green: for a percentage from 90 to 100 or letter A.

86. Search infrastructure as cited in claim 52, further comprise specialized software routines and dynamically generated filters and categories allowing one or more users to find other elements of the network.

87. The Dynamically generated filters and categories as cited in claim 86 further comprising one or more lists that are generated in concordance to the elements the user is searching for. After being generated by the system said filters and categories are shown on the screen and can then be used by the user to limit the results of his search.

88. The add chat and comments action cited in claim 52, further comprising specialized software and database entities allowing users to send and receive instant messages linked to the virtual space of one or more events. Said instant messages are kept and presented in sequential order in said event virtual space.

89. The virtual space of one or more events as cited in claim 88, further comprising a generated profile of the event containing all data related to the event such as: attending competitors, arbiters, winners, statistics, date or location.
